(19) United States
(12) Patent Application Publication
(10) Pub. No.: US 2025/0071462 A1
(43) Pub. Date: Feb. 27, 2025

(54) EARPHONES

(71) Applicant: SHENZHEN SHOKZ CO., LTD., Shenzhen (CN)

(72) Inventors: Haofeng ZHANG, Shenzhen (CN); Yongjian LI, Shenzhen (CN); Jiang XU, Shenzhen (CN); Tao ZHAO, Shenzhen (CN)

(73) Assignee: SHENZHEN SHOKZ CO., LTD., Shenzhen (CN)

(21) Appl. No.: 18/942,751

(22) Filed: Nov. 10, 2024

Related U.S. Application Data
(63) Continuation of application No. PCT/CN2022/136040, filed on Dec. 1, 2022.

(51) Int. Cl. H04R 1/10

(52) U.S. Cl. CPC H04R 1/105; H04R 1/1025; H04R 1/1066

(57) ABSTRACT

Provided is an earphone. The earphone may include a core module and a hook-like structure connected to the core module. The core module may be located on a front side of an ear in a wearing state, and at least part of the hook-like structure may be located on a rear side of the ear in the wearing state. The hook-like structure may include an adapter housing connected to the core module, and an accommodation cavity may be pre-formed in the adapter housing. The earphone may further include an electronic component that is subsequently mounted in the accommodating cavity.

### CROSS-REFERENCE TO RELATED APPLICATIONS

This application is a Continuation of International Patent Application No. PCT/CN2022/136040, filed on Dec. 1, 2022, the entire contents of which are incorporated herein by reference.

### TECHNICAL FIELD

The present disclosure relates to the field of electronic devices, and in particular relates to earphones.

### BACKGROUND

With the continuous popularization of electronic devices, electronic devices have become indispensable social and entertainment tools in people's daily lives. Electronic devices such as earphones have also been widely used in people's daily lives. The electronic devices may be used in conjunction with cell phones, computers, and other terminal devices to provide an auditory feast for users. According to working principles of earphones, they may generally be divided into air-conducting earphones and bone-conducting earphones. Based on ways users wear earphones, they may be categorized as over-ear earphones, on-ear earphones, and in-ear earphones. Furthermore, based on interaction modes between earphones and electronic devices, earphones may be classified as wired earphones and wireless earphones.

### SUMMARY

The present disclosure provides an earphone. The earphone may include a core module and a hook-like structure connected to the core module. The core module may be located on a front side of an ear in a wearing state, and at least part of the hook-like structure may be located on a rear side of the ear in the wearing state. The hook-like structure may include an adapter housing connected to the core module, and an accommodation cavity may be pre-formed in the adapter housing. The earphone may further include an electronic component that is subsequently mounted in the accommodating cavity.

In some embodiments, the core module may include a core housing, and a speaker and a main control circuit board may be disposed in the core housing. The speaker and the electronic component may be respectively coupled with the main control circuit board, and the adapter housing may be plugged and fixed with the core housing.

In some embodiments, the adapter housing may be provided with a first snap structure, the core housing may be provided with a second snap structure, and the first snap structure may extend into the core housing and snap with the second snap structure to cooperate with each other.

In some embodiments, the earphone may further include a flexible circuit board, wherein the flexible circuit board is connected to the electronic component and extends into the core housing, such that the electronic component is connected to the main control circuit board via the flexible circuit board. The speaker may be configured to be connected to the flexible circuit board on an extension path of the flexible circuit board, such that the speaker is connected to the main control circuit board via the flexible circuit board.

In some embodiments, the adapter housing may be pre-formed with through-holes in communication with the accommodation cavity, and the electronic component may include an electrode terminal at least partially provided within the through-holes. The electrode terminal faces toward the ear in the wearing state, the electrode terminal may include a charging positive terminal and a charging negative terminal spaced apart from each other, and the charging positive terminal and the charging negative terminal may be disposed in the corresponding through-hole, respectively.

In some embodiments, the adapter housing may be pre-formed with a blind hole which is not connected to the accommodation cavity, the blind hole may be provided with a magnet, and the magnet and the electrode terminal are visible on a same side surface of the adapter housing.

In some embodiments, the hook-like structure may include an elastic metal wire and a conductor, an end of the elastic metal wire may be connected to the adapter housing, and the conductor may extend along the elastic metal wire and may be threaded in the adapter housing.

In some embodiments, the earphone may further include a battery housing connected to the other end of the flexible metal wire. The conductor may be further threaded in the battery housing, the battery housing may be provided with a battery, and the battery may be connected to the flexible circuit board through the conductor, such that the battery is connected to the main control circuit board via the flexible circuit board.

In some embodiments, an inner side, facing the ear in the wearing state, of the core housing may be provided with an acoustic outlet hole, and a sound wave generated by the speaker may be propagated out through the acoustic outlet hole. The core module may cooperate with a cavum conchae of the ear in the wearing state to form an auxiliary cavity connected to an external ear canal of the ear, and the acoustic outlet hole may be at least partially disposed in the auxiliary cavity.

In some embodiments, the auxiliary cavity may be configured as a semi-open cavity.

### BRIEF DESCRIPTION OF THE DRAWINGS

In order to more clearly illustrate the technical solutions in the embodiments of the present application, the drawings required for use in the description of the embodiments will be briefly introduced below. Obviously, the drawings described below are only some embodiments of the present application. For ordinary technicians in this field, other drawings can be obtained based on these drawings without paying any creative work.

FIG. 1 is a schematic diagram of a profile of a front side of an ear of a user according to some embodiments of the present disclosure;

FIG. 2 is a schematic diagram of an exemplary structure of an earphone according to some embodiments of the present disclosure;

FIG. 3 is a schematic diagram of an exemplary structure of an earphone in a wearing state according to some embodiments of the present disclosure;

FIG. 4 is a schematic diagram of an exemplary structure of an earphone according to some embodiments of the present disclosure;

FIG. 5 is a schematic diagram of an exemplary structure of an earphone according to some embodiments of the present disclosure;

FIG. 6 is a comparative graph of frequency response curves measured at a same listening position when a core module of an earphone is located at different positions of an ear according to some embodiments of the present disclosure;

FIG. 7 is a schematic diagram of a sectional structure of the earphone in FIG. 2 along an A1-A1 sectional direction;

FIG. 8 is a schematic diagram of a sectional structure of the earphone in FIG. 2 along an A2-A2 sectional direction;

FIG. 9 is a schematic diagram of an exemplary structure of an earphone according to some embodiments of the present disclosure;

FIG. 10 is a schematic diagram of an exemplary structure of a core housing according to some embodiments of the present disclosure;

FIG. 11 is a schematic diagram of an exemplary structure of a core housing according to some embodiments of the present disclosure;

FIG. 12 is a schematic diagram of an exemplary structure of a bracket according to some embodiments of the present disclosure;

FIG. 13 is a schematic diagram of an enlarged structure in a B1 region of the earphone in FIG. 8;

FIG. 14 is a schematic diagram of an enlarged structure in a B2 region of the earphone in FIG. 8;

FIG. 15 is a schematic diagram of an exemplary structure of a hook-like structure according to some embodiments of the present disclosure;

FIG. 16 is a schematic diagram of a sectional structure of the hook-like structure in FIG. 15 along an A3-A3 sectional direction;

FIG. 17 is a schematic diagram of a sectional structure of the hook-like structure in FIG. 15 along a sectional direction perpendicular to the A3-A3 sectional direction; and

FIG. 18 is a schematic exploded diagram of the hook-like structure in FIG. 15.

### DETAILED DESCRIPTION

The present disclosure is described in further detail below in conjunction with the accompanying drawings and embodiments. In particular, it should be noted that the following embodiments are only used to illustrate the present disclosure, but do not limit the scope of the present disclosure. Similarly, the following embodiments are only some but not all embodiments of the present disclosure, and all other embodiments obtained by a person of ordinary skill in the art without creative labor fall within the scope of protection of the present disclosure.

References to “embodiments” in the present disclosure mean that particular features, structures, or characteristics described in conjunction with embodiments may be included in at least one embodiment of the present disclosure. It may be understood by those of skill in the art, both explicitly and implicitly, that the embodiments described in the present disclosure may be combined with other embodiments.

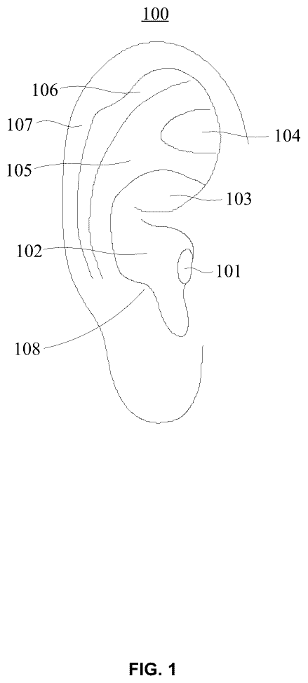

Referring to FIG. 1, an ear 100 of a user may include physiological parts such as an external ear canal 101, a cavum conchae 102, a cymba conchae 103, a triangular fossa 104, an antihelix 105, a scaphoid fossa 106, a helix 107, and an antitragus 108. Although the external ear canal 101 has a certain depth and extends to a tympanic membrane of the ear, for ease of description and referring to FIG. 1, the present disclosure defines the external ear canal 101 as an entrance (i.e., an ear hole) of the ear that is dorsal to the tympanic membrane, unless otherwise specified. Furthermore, physiological parts such as the cavum conchae 102, the cymba conchae 103, the triangular fossa 104, or the like, have a certain volume and a certain depth, and the cavum conchae 102 is in direct communication with the external ear canal 101, which means that the ear hole may be regarded as being located at a bottom of the cavum conchae 102.

Furthermore, different users may have individual differences, resulting in different shapes, sizes, and other dimensional differences of the ear. For ease of description and to minimize (or even eliminate) individual differences between different users, a simulator (e.g. GRAS 45BC KEMAR) with a head and (left and right) ears may be produced based on the ANSI: S3.36, S3.25 and IEC: 60318-7 standards. Thus, in the present disclosure, expressions such as “the user wears the earphone,” “the earphone is in a wearing state,” “in the wearing state,” etc., refer to the earphone described in the present disclosure being worn on the ears of the aforementioned simulator. Of course, precisely due to individual differences between users, when the earphone is worn by different users, there may be some variation compared to when the earphone is worn on the ears of the aforementioned simulator. However, such differences should be tolerated.

It should be noted that in the fields of medicine, anatomy, or the like, three basic planes of the human body, including a sagittal plane, a coronal plane, and a horizontal plane, and three basic axes, including a sagittal axis, a coronal axis, and a vertical axis, may be defined. The sagittal plane refers to a plane perpendicular to a ground and runs along a front-to-rear direction of the body, which divides the body into a left part and a right part; the coronal plane refers to a plane perpendicular to the ground and runs along a left-to-right direction of the body, which divides the body into an anterior part and a posterior part; and the horizontal plane refers to a plane parallel to the ground and runs along a top-to-bottom direction of the body, which divides the body into an upper part and a lower part. Correspondingly, the sagittal axis is an axis along the front-to-rear direction of the body and perpendicular to the coronal plane, the coronal axis is an axis along the left-to-right direction of the body and perpendicular to the sagittal plane, and the vertical axis is an axis along the top-to-bottom direction of the body and perpendicular to the horizontal plane. Furthermore, the “front side of the ear” described in the present disclosure is a concept relative to the “rear side of the ear,” where the “front side of the ear” refers to a side of the ear that is away from the head, and the “rear side of the ear” refers to a side of the ear that is toward the head, both of which are directed to the ear of the user. Observing the ear of the above-described simulator along a direction of the coronal axis of the human body, a schematic diagram of the profile of the front side of the ear as shown in FIG. 1 may be obtained.

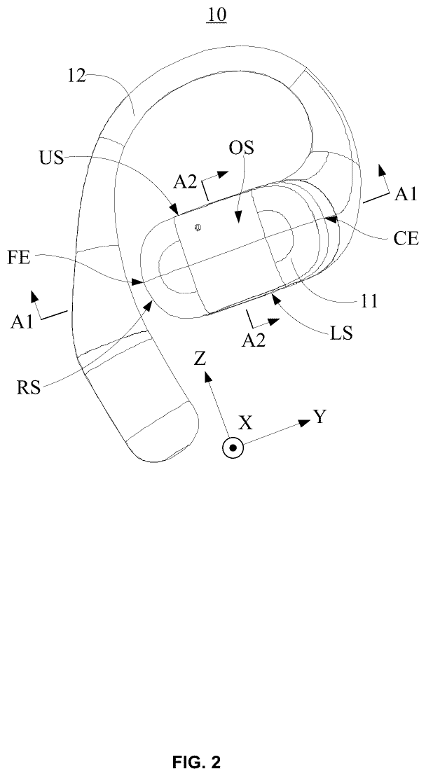

By way of example, referring to FIGS. 2 to 5, an earphone 10 may include a core module 11 and a hook-like structure 12 connected to the core module 11. The core module 11 may be disposed on a front side of an ear of a user in a wearing state, and at least part of the hook-like structure 12 may be disposed on a rear side of the ear in the wearing state to enable the earphone 10 to be disposed on the ear in the wearing state. The core module 11 may have a connecting end (CE) that is connected to the hook-like structure 12 and a free end (FE) that is not connected to the hook-like structure 12. Furthermore, the core module 11 may be configured not to block an external ear canal in the wearing state, making the earphone 10 an “open earphone.” It should be noted that, due to individual differences between different users, when the earphone 10 is worn by different users, the core module 11 may partially cover the external ear canal, but the external ear canal remains unblocked.

In order to improve the stability of the earphone 10 in the wearing state, the earphone 10 may be configured in any one of the following ways or a combination thereof. First, at least a portion of the hook-like structure 12 may be configured as a mimetic structure that fits with at least one of the rear side of the ear and the head to increase a contact area of the hook-like structure 12 with the ear and/or the head so as to increase a resistance of the earphone 10 to being dislodged from the ear. Second, at least a portion of the hook-like structure 12 may be configured as an elastic structure to enable the hook-like structure 12 to have a certain amount of deformation in the wearing state, so as to increase a positive pressure of the hook-like structure 12 on the ear and/or the head, thereby increasing the resistance of the earphone 10 to being dislodged from the ear. Third, at least a portion of the hook-like structure 12 may be configured to abut against the head in the wearing state, so as to form a reaction force that presses on the ear, thereby causing the core module 11 to press on the front side of the ear, and increasing the resistance of the earphone 10 to being dislodged from the ear. Fourth, the core module 11 and the hook-like structure 12 may be configured to hold a physiological part such as a region where the antihelix is located, a region where the cavum conchae is located, or the like, from the front side and the rear side of the ear in the wearing state, thereby increasing the resistance of the earphone 10 to being dislodged from the ear. Fifth, the core module 11 or an auxiliary structure connected thereto may be configured to at least partially extend into a physiological part such as the cavum conchae, the cymba conchae, the triangular fossa, and the scaphoid fossa, so as to increase the resistance of the earphone 10 to being dislodged from the ear.

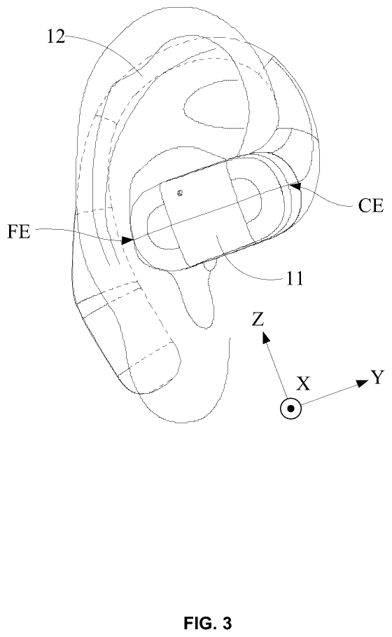

By way of exemplary, referring to FIG. 3, in the wearing state, the free end (FE) of the core module 11 may extend into the cavum conchae 102. The core module 11 and the hook-like structure 12 may be configured to jointly clamp an ear region corresponding to the cavum conchae from a front side and a rear side of the ear region, thereby increasing the resistance of the earphone 10 to being dislodged from the ear, and improve the stability of the earphone 10 in the wearing state. For example, the free end FE is pressed against the cavum conchae 102 in a thickness direction X. As another example, the free end FE is pressed against the cavum conchae 102 in a length direction Y and a width direction Z.

It should be noted that in the wearing state, not only the free end FE of the core module 11 extends into the cavum conchae 102, a positive projection of the core module 11 may fall on the antihelix 105, and the positive projection of the core module 11 may also fall on the left and right sides of the head and be located on the front side of the ear in the sagittal axis of the human body. In other words, the hook-like structure 12 may support the core module 11 to be worn at wearing positions such as the cavum conchae 102, the antihelix 105, the front side of the ear, etc.

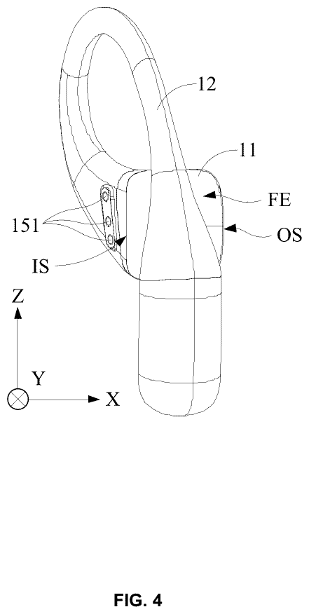

By way of exemplary, referring to FIG. 3 and FIG. 4, in the wearable state the core module 11 may have an inner side surface IS facing toward the ear in a thickness direction X of the core module, an outer side surface OS facing away from the ear in the thickness direction X, and a connection surface connecting the inner side surface IS and the outer side surface OS. The thickness direction X may be defined as a direction in which the core module 11 is close to or away from the ear in the wearing state. Furthermore, at least a portion of the connecting surface is disposed within the cavum conchae in the wearing state and forms a first contact zone with the front side of the ear, and the hook-like structure 12 forms a second contact zone with the rear side of the ear region in the wearing state. The second contact zone and the first contact zone at least partially overlap in an ear thickness direction of the ear region. In this way, not only can the core module 11 and the hook-like structure 12 jointly clamp the ear region from the front side and the rear side of the ear, but also a clamping force formed is mainly a compressive stress, which is conducive to improving the stability and comfort of the earphone 10 in the wearing state.

It should be noted that in the wearing state and viewed in a direction of the coronal axis, the core module 11 may be configured in a shape of a circle, an oval, a rounded square, a rounded rectangle, or the like. If the core module 11 is configured as a circle, an ellipse, or the like, the aforementioned connecting surface may be referred to as a curved side of the core module 11. If the core module 11 is configured as a rounded square, a rounded rectangle, or the like, the aforementioned connecting surface may include a lower side surface LS, an upper side surface US, and a rear side surface RS mentioned below. Further, the core module 11 may have a length direction Y and a width direction Z that are orthogonal to each other and perpendicular to the thickness direction X. The length direction Y may be defined as a direction in which the core module 11 is close to or away from the back of the head of the user in the wearing state, and the width direction Z may be defined as a direction in which the core module 11 is near or away from the top of the head of the user in the wearing state. Thus, for ease of description, this embodiment takes the core module 11 configured as a rounded rectangle as an illustrative example. A length of the core module 11 in the length direction Y may be greater than a width of the core module 11 in the width direction Z.

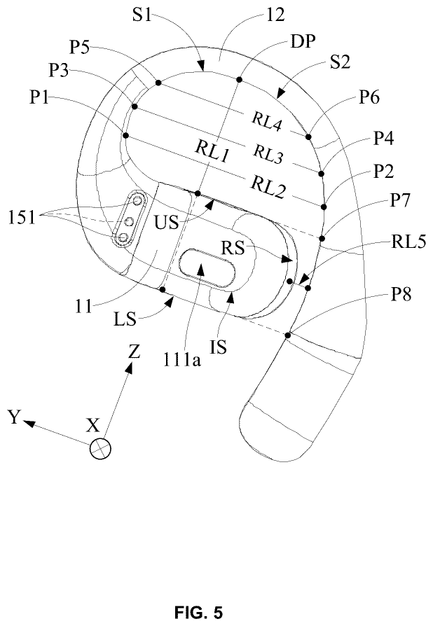

By way of exemplary, referring to FIG. 2, FIG. 3, and FIG. 5, in the wearing state and viewed in the direction of the coronal axis of the human body, the connecting end CE is closer to a top of the head compared to the free end FE so as to allow the free end FE to extend into the cavum conchae. Based on this, an angle between the length direction Y and a direction of the sagittal axis of the human body may be between 15° and 60°. If the aforementioned angle is too small, the free end FE may not extend into the cavum conchae, and an acoustic outlet hole 111a on the core module 11 may be too far away from the external ear canal. If the aforementioned angle is too large, the free end FE may not extend into the cavum conchae 102, and the external ear canal may be blocked by the core module 11. In other words, the above-described configuration not only allows the free end FE to extend into the cavum conchae 102, but also makes the acoustic outlet hole 111a on the core module 11 have a suitable distance from the external ear canal, so that the user can hear more sound waves generated by the core module 11 while ensuring that the external ear canal is not blocked.

By way of example, referring to FIG. 4, a positive projection of the hook-like structure 12 on a reference plane (e.g., the XZ plane in FIG. 4) perpendicular to the length direction Y partially overlaps with a positive projection of the free end FE of the hook-like structure 12 on the reference plane. An overlapping region formed by the overlapping of the positive projection of the hook-like structure 12 on the aforementioned reference plane and the positive projection of the free end FE on the same reference plane is located, in the thickness direction X, between the inner side surface IS and the outer side surface OS. Through this configuration, not only can the core module 11 and the hook-like structure 12 jointly clamp the ear region from the front side and the rear side of the ear region, but also the clamping force formed is mainly a compressive stress, which is conducive to improving the stability and comfort of the earphone 10.

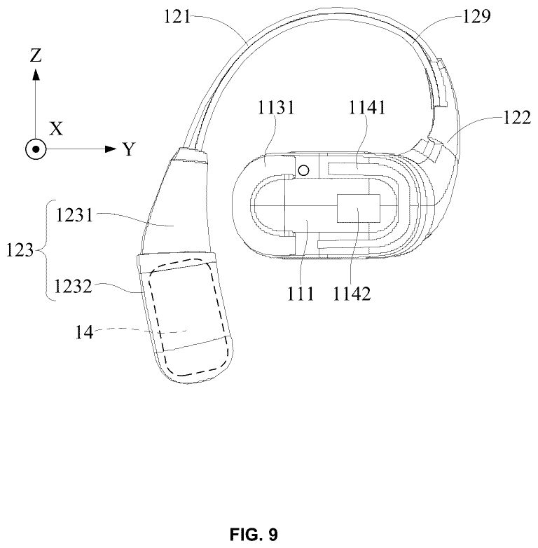

Furthermore, referring to FIG. 2, FIG. 4, FIG. 5, and FIG. 9, the hook-like structure 12 may include an elastic metal wire 121 connected to the core module 11 and a battery housing 123 connected to an end of the elastic metal wire 121 that is away from the core module 11. A battery 14 may be provided in the battery housing 123, the battery 14 is coupled to the core module 11, and a positive projection of the battery housing 123 on the reference plane partially overlaps with a positive projection of the free end (FE) of the hook-like structure 12 on the reference plane. Through this configuration, the battery housing 123 may support the ear from the rear side of the ear when the free end FE abuts against the cavum conchae 102, which is conducive to improving the stability of the earphone 10 in the wearing state. The battery housing 123 may include a cover shell 1231 connected to the elastic metal wire 121 and a battery compartment 1232 connected to the cover shell 1231, and the battery compartment 1232 and the cover shell 1231 cooperate to form a cavity structure that houses the battery 14.

By way of example, referring to FIG. 5, in the wearing state, the core module 11 may have an upper side surface US facing away from the external ear canal in the width direction Z, a lower side surface LS facing toward the external ear canal in the width direction Z, and a rear side surface RS that connects the upper side surface US and the lower side surface LS. The rear side surface RS is located at an end of the core module 11 that faces a rear side of the head in the length direction Y when the core module 11 is in the wearing state and at least partially located in the cavum conchae 102. An edge of a side, facing toward the core module 11, of a positive projection of the hook-like structure 12 on a reference plane (e.g., the YZ plane in FIG. 5) that is perpendicular to the thickness direction X may be divided into a first section S1 and a second section S2 with a continuous arc transition. A dividing point DP between the first section S1 and a second section S2 may be located at a position where the edge is farthest from the upper side surface US of the core module 11 in the width direction Z. Further, an overall curvature of the hook-like structure 12 in the first section S1 may be greater than an overall curvature of the hook-like structure 12 in the second section S2. This configuration not only enables the free end FE to extend into the cavum conchae 102, but also allows the hook-like structure 12 to cooperate with the core module 11 to provide a suitable clamping force.

It should be noted that the above overall curvature may be used to qualitatively characterize the degree of curvature of the different sections of the hook-like structure 12, wherein a radius of curvature of each section is a constant value or varies continuously. Thus, there exists at least one point within the first section S1 having a radius of curvature that is less than the radius of curvature of any point within the second section S2. Furthermore, the overall curvature described above may also be quantitatively characterized in terms of an average radius of curvature, i.e., an average of the radius of curvature of N points on each section.

Further, in an extension direction of the hook-like structure 12, a length of the second section S2 may be greater than a length of the first section S1, so as to facilitate the clamping of the ear by the hook-like structure 12 with the core module 11, and increase a contact area between the hook-like structure 12 and a skin of the user, which is conducive to improving the stability of the earphone 10 in the wearing state.

In some embodiments, the earphone 10 has a first reference line segment RL1 parallel to the width direction Z. A starting point of the first reference line segment RL1 is a point where the first reference line segment RL1 intersects with the upper side surface US, and an ending point of the first reference line segment RL1 is the dividing point DP. A second reference line segment RL2, a third reference line segment RL3, and a fourth reference line segment RL4 described later are sequentially increasingly farther away from the starting point of the first reference line segment RL1 in the width direction. Further, a length of the first reference line segment RL1 may bein a range of 13 mm to 20 mm. If the length of the first reference line segment RL1 is too small, the free end FE may not extend into the cavum conchae 102, and the acoustic outlet hole 111a on the core module 11 may be too far away from the external ear canal. If the length of the first reference line segment RL1 is too large, the free end FE may not extend into the cavum conchae 102, and the external ear canal may be blocked by the core module 11. In other words, the above-described configuration not only allows the free end FE to extend into the cavum conchae 102, but also makes the acoustic outlet hole 111a on the core module 11 have a suitable distance from the external ear canal, so that the user can hear more sound waves generated by the core module 11 while ensuring that the external ear canal is not blocked.

Further, a second reference line segment RL2 passing ¼ of the first reference line segment RL1 and parallel to the length direction Y may intersect with the first section S1 and the second section S2 at a first intersection point P1 and a second intersection point P2, respectively. A distance between the first intersection point P1 and the starting point of the first reference line segment RL1 may be in a range of 9 mm to 15 mm, and a distance between the second intersection point P2 and the starting point of the first reference line segment RL 1 may be in a range of 12 mm to 19 mm. A third reference line segment RL3 passing ½ of the first reference line segment RL1 and parallel to the length direction Y may intersect with the first section S1 and the second section S2 at a third intersection point P3 and a fourth intersection point P4, respectively. A distance between the third intersection point P3 and the starting point of the first reference line segment RL 1 may be in a range of 11 mm to 18 mm, and a distance between the fourth intersection point P4 and the starting point of the first reference line segment RL 1 may be in a range of 12 mm to 19 mm. A fourth reference line segment RL 4 passing ¾ of the first reference line segment RL 1 and parallel to the length direction Y may intersect with the first section S1 and the second section S2 at a fifth intersection point P5 and a sixth intersection point P6, respectively. A distance between the fifth intersection point P5 and the starting point of the first reference line segment RL 1 may be in a range of 12 mm to 19 mm, and a distance between the sixth intersection point P6 and the starting point of the first reference line segment RL1 may be in a range of 12 mm to 19 mm. This configuration makes the hook-like structure 12 better fit the ear when the free end FE of the core module 11 extends into the cavum conchae 102 and the acoustic outlet hole 111a on the core module 11 is at a suitable distance from the external ear canal.

In some embodiments, a fifth reference line segment RL5 with a shortest distance in the length direction Y is formed between the second section S2 and the rear side surface RS, and a length of the fifth reference line segment RL5 may be in a range of 2 mm to 3 mm. If the length of the fifth reference line segment RL5 is too small, it is likely to lead to the core module 11 and the hook-like structure 12 having an excessively large clamping force on the ear and causing wearing discomfort. If the length of the fifth reference line segment RL5 is too large, it is likely to cause the clamping force of the core module 11 and the hook-like structure 12 on the ear to be too small and cause wearing instability. In other words, the aforementioned configuration ensures both stability and comfort of the earphone 10 in the wearing state.

Further, the fifth reference line segment RL5 is defined as follows: a point where the fifth reference line segment RL5 intersects with the rear side surface RS is designated as a starting point of the fifth reference line segment RL5, and a point where the fifth reference line segment RL5 intersects with the second section S2 is designated as an end point of the fifth reference line segment RL5. A positive projection of the starting point of the first reference line segment RL1 along the length direction Y of the core module 11 may intersect with the second section S2 at a seventh intersection point P7, and a positive projection of an intersection point of a reverse extension line of the first reference line segment RL1 and the lower side surface LS along the length direction Y may intersect with the second section S2 at an eighth intersection point P8. A distance between the seventh intersection point P7 and the starting point of the fifth reference line segment RL5 may be in a range of 5 mm and 9 mm, and a distance between the eighth intersection point P8 and the starting point of the fifth reference line segment RL5 may be in a range of 5 mm to 9 mm. This configuration makes the hook-like structure 12 better fit the ear while ensuring stability and comfort of the earphone 10 in the wearing state.

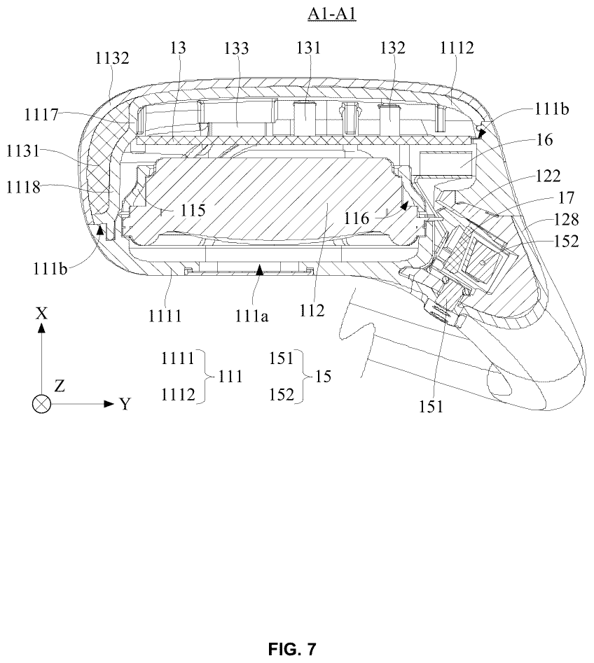

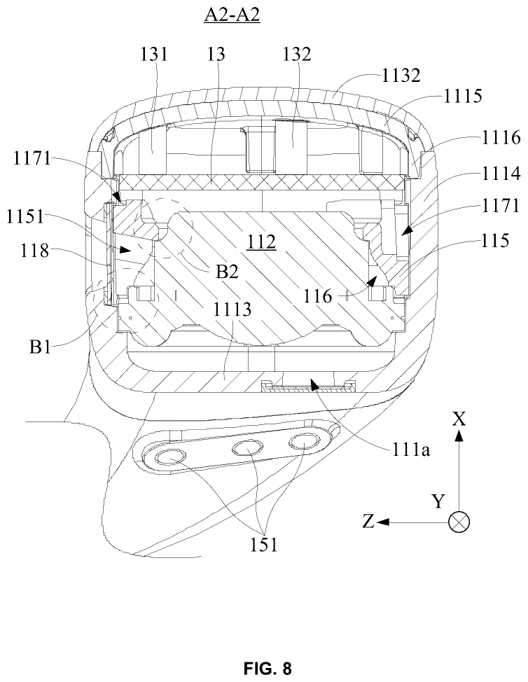

By way of example, referring to FIG. 7, FIG. 8, and FIG. 5, the core module 11 may include a core housing 111 connected to the hook-like structure 12 and a speaker 112 disposed within the core housing 111. An inner side surface (e.g., the inner side surface IS mentioned above) of the core housing 111 facing the ear in the wearing state may be provided with an acoustic outlet hole 111a, and a sound wave generated by the speaker 112 may propagate out through the acoustic outlet hole 111a so as to be easily transmitted into the external ear canal. It should be noted that the acoustic outlet hole 111a may also be provided on a side of the core housing 111 corresponding to the lower side surface LS, and may also be provided at a corner between the aforementioned inner side surface IS and the lower side surface LS. Further, the speaker 112 may include a magnetic circuit system, a voice coil extending into the magnetic circuit system, and a diaphragm connected to the voice coil. A magnetic field generated by the voice coil after being energized interacts with the magnetic field formed by the magnetic circuit system, thereby driving the diaphragm to generate mechanical vibration, which in turn generates sound by propagation through a medium such as air.

Further, referring to FIG. 7 to FIG. 9, the earphone 10 may include a main control circuit board 13 disposed within the core housing 111 and a battery 14 disposed at an end of the hook-like structure 12 away from the core module 11. The battery 14 and the speaker 112 are each coupled to the main control circuit board 13 to allow the battery 14 to power the speaker 112 under the control of the main control circuit board 13. Of course, the battery 14 and the speaker 112 may also be provided within the core housing 111, and the battery 14 may be closer to the connecting end CE while the speaker 112 may be closer to the free end FE.

By way of example, referring to FIG. 3 and FIG. 1, since the cymba conchae 103 has a certain volume and depth, there is a distance between an inner side surface of the core housing 111 and the cavum conchae 102 after the free end FE of the core module 11 extends into the cavum conchae 102. In other words, the core module 11 may cooperate with the cavum conchae 102 to form an auxiliary cavity connected to the external ear canal in the wearing state, and the acoustic outlet hole 111a may be at least partially disposed within the auxiliary cavity. Therefore, in the wearing state, sound waves generated by the speaker 112 and propagated through the acoustic outlet hole 111a may be constrained by the auxiliary cavity, i.e., the auxiliary cavity may converge the sound waves so that the sound waves may propagate more into the external ear canal, thereby increasing a volume and sound quality of the sound heard by a user in a near field, which is conducive to improving an acoustic effect of the earphone 10. Furthermore, as the core module 11 is configured not to block the external ear canal in the wearing state, the auxiliary cavity may be in a semi-open configuration. Thus, the sound waves produced by the speaker 112 and transmitted through the acoustic outlet hole 111a may primarily propagate into the external ear canal, while a small portion of the sound waves may pass through the gap between the core module 11 and the ear (e.g., a part of the cavum conchae 102 not covered by the core module 11) to the outside of the earphone 10 and the ear, creating a first leakage sound in a far field. Meanwhile, the core module 11 typically has one or more acoustic holes (e.g., a pressure relief hole 111c described below), and sound waves transmitted through the one or more acoustic holes may create a second leakage sound in the far field. A phase of the first leakage sound and a phase of the second leakage sound (which are close to each other) are generally opposite to each other, allowing the first leakage sound and the second leakage sound to cancel each other out in the far field, which helps to reduce leakage sound from the earphone 10 in the far field.

Further, the earphone 10 may include an adjusting mechanism connecting the core module 11 and the hook-like structure 12, and different users may adjust a position of the core module 11 in the wearing state via the adjusting mechanism to make the core module 11 located at a suitable position, thereby enabling the core module 11 to form the auxiliary cavity with the cavum conchae 102. In addition, the adjusting mechanism allows the user to adjust the earphone 10 to be worn to a more stable and comfortable position.

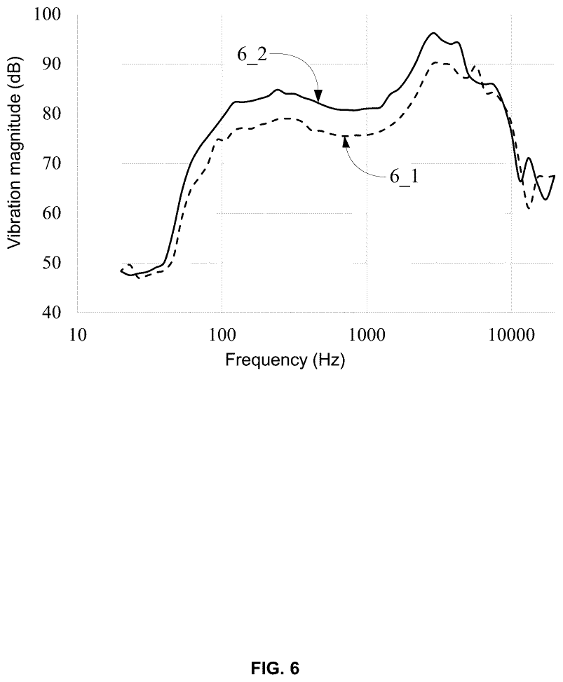

By way of example, referring to FIG. 6, the earphone 10 may be worn on the above simulator, then the position of the core module 11 on the ear of the above simulator may be adjusted, and a frequency response curve of the earphone 10 may be obtained via a detector (e.g., a microphone) disposed within the external ear canal (e.g., a position of the tympanic membrane, i.e., a listening position) of the above simulator, so as to simulate a sound-hearing effect of a user after wearing the earphone 10. The frequency response curve may characterize a change relationship between a vibration magnitude and a vibration frequency. A transverse coordinate of the frequency response curve denotes the vibration frequency, unit in Hz, and a vertical coordinate of the frequency response curve denotes the vibration magnitude, unit in dB. As shown in FIG. 6, a curve 6_1 may represent a frequency response curve of the core module 11 when the core module 11 is not cooperating with the cavum conchae 102 to form the auxiliary cavity in the wearing state, and a curve 6_2 may represent a frequency response curve of the core module 11 when the core module 11 is cooperating with the cavum conchae 102 to form the auxiliary cavity in the wearing state. Comparing the two frequency response curves illustrated in FIG. 6, it may be directly and unquestionably concluded that the curve 6_2 is located above the curve 6_1 as a whole. In other words, compared to the scenario when the core module 11 is not cooperating with the cavum conchae 102 in the wearing state, it is more conducive to improving the acoustic effect of the earphone 10 when the core module 11 cooperates with the cavum conchae 102 to form the auxiliary cavity with the concha cavity in the wearing state.

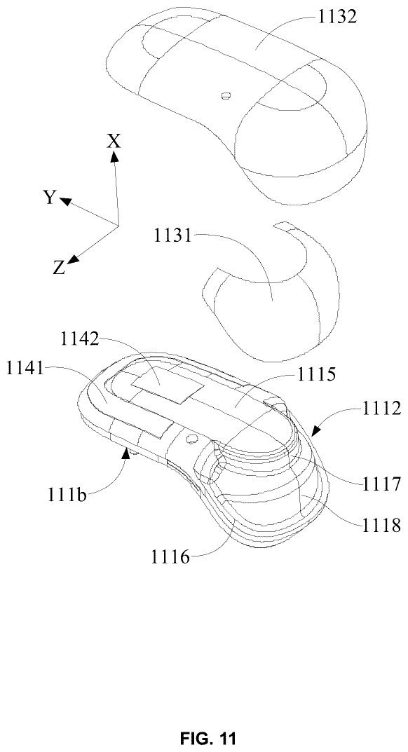

By way of example, referring to FIG. 7, FIG. 9, and FIG. 11, the core module 11 may include a flexible embedding block 1131 disposed outside of the core housing 111, and a hardness of the flexible embedding block 1131 may be less than a hardness of the core housing 111. The core housing 111 may be a plastic component, the flexible embedding block 1131 may be made of silicone, rubber, etc., and may be formed on a predetermined region of the core housing 111 by injection molding. Further, the flexible embedding block 1131 may at least partially cover a region of the core housing 111 corresponding to the free end FE such that at least a portion of the core module 11 abuts against the cavum conchae 102 via the flexible embedding block 1131 within the cavum conchae 102. In other words, a portion of the core housing 111 that extends into the cavum conchae 102 and is in contact with the cavum conchae 102 may be covered by the flexible embedding block 1131. Through this configuration, when the core module 11 abuts against the cavum conchae 102, for example, when the core module 11 and the hook-like structure 12 are configured to jointly clamp the ear region corresponding to the cavum conchae 102 from the front side and the rear side of the ear region, the flexible embedding block 1131 has a cushioning effect between the core housing 111 and the ear (e.g., the ear region) to alleviate the pressure of the earphone 10 on the ear, which is conducive to improving the comfort of the earphones 10 in the wearing state.

Exemplarily, the flexible embedding block 1131 may continuously overlay at least a portion of the core housing 111 corresponding to the rear side surface RS, the upper side surface US, and the lower side surface LS. For example, more than 90% of a region of the core housing 111 corresponding to the rear side surface RS is covered by the flexible embedding block 1131, and about 30% of each of regions of the core housing 111 corresponding to the upper side surface US and the lower side surface LS is covered by the flexible embedding block 1131. This configuration balances the comfort of the earphone 10 in the wearing state and the need to provide structural parts such as the speaker 112 in the core housing 111.

In some embodiments, the flexible embedding block 1131 may be configured as a U-shape when viewed along the thickness direction X.

In some embodiments, a portion of the flexible embedding block 1131 corresponding to the lower side surface LS may abut against the antitragus 108. A thickness of a portion of the flexible embedding block 1131 corresponding to the rear side surface RS may be less than a thickness of a portion of the flexible embedding block 1131 corresponding to the upper side surface US and a thickness of a portion of the flexible embedding block 1131 corresponding to the lower side surface LS, respectively, so as to ensure wearing comfort even if the core module 11 abuts against an uneven position within the cavum conchae 102.

By way of example, referring to FIG. 7 and FIG. 8, the core housing 111 may include an inner core housing 1111 and an outer core housing 1112 that are snapped together with each other in the thickness direction X. The inner core housing 1111 is closer to the ear in the wearing state compared to the outer core housing 1112. A parting surface 111b between the outer core housing 1112 and the inner core housing 1111 may be inclined in a direction close to the free end FE towards a side on which the inner core housing 1111 is located, such that the flexible embedding block 1131 is arranged as close as possible to a region of the outer core housing 1112 corresponding to the free end FE of the core module 11. For example, referring to FIG. 11, the flexible embedding block is entirely arranged in a region of the outer core housing 1112 corresponding to the free end FE of the core module 11, thereby simplifying the structure of the core module 11 and reducing processing costs.

By way of example, referring to FIG. 7, FIG. 8, and FIG. 11, the core module 11 may include a flexible cladding 1132, wherein the flexible cladding 1132 has a hardness that is less than the hardness of the core housing 111. The core housing 111 may be a plastic fabrication. The flexible cladding 1132 may be made of silicone, rubber, etc., and may be formed on a predetermined region of the core housing 111 by injection molding, glue attachment, etc. Further, the flexible cladding 1132 may integrally cover at least a portion of an outer surface of the flexible embedding block 1131 and at least a portion of an outer surface of the outer core housing 1112 that is not covered by the flexible embedding block 1131, thereby enhancing the consistency of the core module 11 in appearance. Of course, the flexible cladding 1132 may further cover an outer surface of the inner core housing 1111. The hardness of the flexible embedding block 1131 is less than the hardness of the flexible cladding 1132 to allow the flexible embedding block 1131 to be soft enough. In addition, the flexible cladding 1132 also improves the comfort of the earphone 10 in the wearing state and has a certain structural strength to protect the flexible embedding block 1131. Further, an area of the outer surface of the flexible embedding block 1131 may be between 126 mm² and 189 mm². If the area is too small, it is likely to lead to deterioration of the comfort of the core module 11 in the wearing state. If the area is too large, it may result in an excessively large volume of the core module 11, as well as an excessively large area of the flexible embedding block 1131 not abutting against the cavum conchae 102, which may not provide enough support and contradict the original intention of providing the flexible embedding block 1131. Further, a thickness of the flexible cladding 1132 is less than a thickness of the outer core housing 1112.

By way of example, referring to FIG. 11 and FIG. 9, the core module 11 may include a metal function pattern such as an antenna pattern 1141 and/or a touch pattern 1142 provided between the outer core housing 1112 and the flexible cladding 1132. Among them, the antenna pattern 1141 can be molded on the outside of the outer core housing 1112 with the aid of laser-direct-structuring (LDS); the touch pattern 1142 can be molded on the outside of the outer core housing 1112 with the aid of laser-direct-structuring (LDS), or it can be a flexible touch circuit board pasted on the outside of the outer core housing 1112. Further, the outer core housing 1112 is provided with metalized holes connected to the antenna pattern 1141 and the touch pattern 1142, respectively. The antenna pattern 1141 may be molded on an outer side of the outer core housing 1112 using a laser-direct-structuring (LDS) technology. The touch pattern 1142 may be molded on the outer side of the outer core housing 1112 using the LDS technology, or the touch pattern 1142 may be a flexible touch circuit board pasted on the outer side of the outer core housing 1112. Further, the outer core housing 1112 may be provided with metalized holes connected to the antenna pattern 1141 and the touch pattern 1142, respectively. At this time, since the main control circuit board 13 is provided in the core housing 111, for example, the main control circuit board 13 may be connected to the outer core housing 1112, t the main control circuit board 13 may be connected to the outer core housing 1112 through elastic metal members such as a pogo-PIN, a metal dome, etc., that are in contact with inner walls of the corresponding metalized holes. For example, the antenna pattern 1141 and the touch pattern 1142 may be respectively connected to a pogo-PIN 131 and a pogo-PIN 132 soldered to the main control circuit board 13. Correspondingly, the speaker 112 may be disposed on a side of the main control circuit board 13 away from the outer core housing 1112. In this way, compared to arranging the antenna pattern 1141 and the touch pattern 1142 respectively on an inner side of the outer core housing 1112 toward the speaker 112, arranging the antenna pattern 1141 on the outer side of the outer core housing 1112 can increase a distance between the antenna pattern 1141 and the main control circuit board 13, thereby increasing an antenna clearance area, and increasing an anti-interference capability of the antenna pattern 1141. Arranging the touch pattern 1142 on the outer side of the outer core housing 1112 can shorten a distance between the touch pattern 1142 and an external signal trigger source (e.g., a finger of a user), thereby reducing a touch distance and increasing sensitivity of the touch pattern 1142 to user triggers.

In some embodiments, the antenna pattern 1141 may surround a periphery of the touch pattern 1142 to fully utilize space on the outer side of the outer core housing 1112. The antenna pattern 1141 may be configured as a U-shape and the touch pattern 1142 may be configured as a square shape.

Further, the core module 11 may include a microphone 133 soldered to the main control circuit board 13, and the microphone 133 may collect a voice of the user and an ambient sound through a sound collection through-hole provided on the outer core housing 1112. The microphone 133 may be further pressed against the outer core housing 1112 when the main control circuit board 13 is connected to the outer core housing 1112.

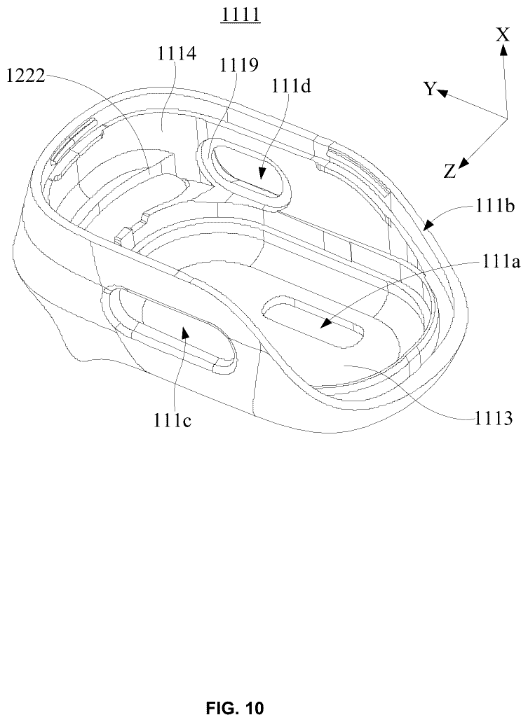

Exemplarily, referring to FIG. 10 and FIG. 11, the inner core housing 1111 may include a bottom wall 1113 and a first side wall 1114 connected to the bottom wall 1113, and the outer core housing 1112 may include a top wall 1115 and a second side wall 1116 connected to the top wall 1115, the second side wall 1116 and the first side wall 1114 being snapped to each other along the parting surface 111b, and supported by each other. When viewed along the width direction Z, and in a reference direction (e.g., a direction opposite to the direction indicated by the arrow Y in FIGS. 10 and 11) in which the connecting end CE points to the free end FE, a portion of the first side wall 1114 close to the free end FE is progressively closer to the bottom wall 1113 in the thickness direction X, and a portion of the second side wall 1116 close to the free end FE is progressively farther away from the top wall 1115 in the thickness direction X, such that the parting surface 111b, in the direction close to the free end FE, is inclined toward the side on which the inner core housing 1111 is located. At this point, at least a portion of the flexible embedding block 1131 is disposed on the outer side of the second sidewall 1116. For example, referring to FIG. 11 and FIG. 9, a portion of the flexible embedding block 1131 is disposed on the outer side of the top wall 1115 and a portion of the flexible embedding block 1131 is disposed on the outer side of the second side wall 1116. Correspondingly, the sound outlet hole 111a may be provided on the bottom wall 1113. Of course, the sound outlet hole 111a may also be provided on a side of the first side wall 1114 corresponding to the lower side LS, and may also be provided at a corner between the first side wall 1114 and the bottom wall 1113. Furthermore, the antenna pattern 1141 and the touch pattern 1142 and their respective metallization holes may be provided on the top wall 1115, and the sound collection through-hole of the microphone 133 may also be provided on the top wall 1115.

By way of example, referring to FIG. 7 and FIG. 11, the outer core housing 1112 may be provided with an embedding groove at least partially disposed on the second sidewall 1116, so as to ensure a smooth transition between an outer surface of a region of the outer core housing 1112 not covered by the flexible embedding block 1131 and the outer surface of the flexible embedding block 1131. A region in which the flexible embedding block 1131 is located in FIG. 7 may be simply regarded as the aforementioned embedding groove. This configuration is not only conducive to the flexible embedded block 1131 being piled up on the outer core housing 1112 during an injection molding process, thereby avoiding overflow of the flexible embedded block 1131, but is also conducive to the improvement of the appearance quality of the core module 11, thereby avoiding the core module 11 from having a pitted surface.

Further, the second side wall 1116 may include a first sub-sidewall segment 1117 and a second sub-sidewall segment 1118 coupled to the first sub-sidewall segment 1117. The first sub-sidewall segment 1117 is closer to the top wall 1115 in the thickness direction X compared to the second sub-sidewall segment 1118, and the second sub-sidewall segment 1118 protrudes toward an outer side of the core housing 111 compared to the first sub-sidewall segment 1117. In short, the second side wall 1116 may be configured as a step-like structure. This configuration is not only conducive to the flexible embedding blocks 1131 being piled up on the outer core housing 1112 during injection molding to avoid overflowing of the flexible embedding blocks 1131, but also enables the core module 11 to better abut against the cavum conchae 102 via the flexible embedding block 1131, thereby improving the comfort of the earphone 10 in the wearing state.

Further, the main control circuit board 13 may be connected to the outer core housing 1112. For example, the main control circuit board 13 may be secured to a thermally fused post coupled to the top wall 1115 and may partially overlap the first sub-sidewall segment 1117 in the thickness direction X. The speaker 112 may partially overlap the second sub-sidewall segment 1118 in the thickness direction X. This configuration allows a sufficiently large speaker 112 to be disposed in the core housing 111, thereby enhancing a volume of the sound produced by the earphone 10.

By way of example, referring to FIG. 10 and FIG. 8, the core housing 111 may be provided with a pressure relief hole 111c, and the pressure relief hole 111c allows a space on a side of the speaker 112 toward the main control board 13 to be connected with an external environment, so that air may freely move in and out of the aforementioned space, which is conducive to reducing a resistance of a diaphragm of the speaker 112 during vibration. The pressure relief hole 111c may be oriented toward the top of the head in the wearing state, which prevents the leakage sound (i.e., the second leakage sound described above) transmitted through the pressure relief hole 111c from being heard. Based on the Helmholtz resonance cavity, a diameter of the pressure relief hole 111c may be as large as possible to allow a resonance frequency of the second leakage sound to be shifted as much as possible towards a relatively high frequency band (e.g., a frequency range greater than 4 kHz), which further prevents the second leakage sound from being heard.

Further, the core housing 111 may be provided with a sound tuning hole 111d, the sound tuning hole 111d causing the resonance frequency of the second leakage sound to be shifted as much as possible towards a relatively high frequency band (e.g., a frequency range greater than 4 kHz), which further prevents the second leakage sound from being heard. An area of the sound tuning hole 111d may be smaller than an area of the pressure relief hole 111c to allow more of the space on the side of the speaker 112 toward the main control circuit board 13 to be connected to the external environment through the pressure relief hole 111c. Furthermore, a distance between the sound outlet hole 111a and the pressure relief hole 111c in the width direction Z may be larger than a distance between the sound outlet hole 111a and the sound tuning hole 111d in the width direction Z to avoid the sound waves propagating through the sound outlet hole 111a and the pressure relief hole 111c from canceling each other in the near field, which is conducive to increasing a volume of the sound that propagates through the sound outlet hole 111a and heard by the user. Correspondingly, the sound tuning hole 111d is located closer to the connecting end CE than the acoustic outlet hole 111a in order to increase a spacing between the sound outlet hole 111a and the sound tuning hole 111d in the length direction Y, so as to prevent a sound wave propagated through the acoustic outlet hole 111a and a sound wave propagated through the sound tuning hole 111d from canceling each other out in a near field, thereby increasing the volume of the sound propagated through the sound output hole 111a and heard by the user.

By way of example, referring to FIG. 10, the sound outlet hole 111a, the pressure relief hole 111c, and the sound tuning hole 111d may be disposed on the inner core housing 1111. For example, the sound outlet hole 111a may be disposed on the bottom wall 1113 while the pressure relief hole 111c and the sound tuning hole 111d may be disposed on the first side wall 1114. The pressure relief hole 111c and the sound tuning hole 111d may be disposed on two opposite sides of the first side wall 1114 along the width direction Z, respectively. By disposing the sound outlet hole 111a, the pressure relief hole 111c, and the sound tuning hole 111d on the inner core housing 1111, a structure of the outer core housing 1112 is simplified, which is conducive to reducing processing costs. In addition, since the pressure relief hole 111c and the sound tuning hole 111d are respectively provided on the two opposite sides of the first sidewall 1114 along the width direction Z, the parting surface 111b can be symmetrically provided with respect to a reference plane perpendicular to the width direction Z, which is conducive to improving the appearance of the core module 11.

By way of example, referring to FIGS. 7 and 8, the core module 11 may include a bracket 115 disposed within the core housing 111, and the bracket 115 and the speaker 112 may be enclosed to form an acoustic cavity 116 to enable the acoustic cavity 116 to be separated from other structures (e.g., the main control circuit board 13, or the like) within the core housing 111, which is conducive to improving an acoustic performance of the core module 11. The core housing 111 may include an acoustic hole, for example, the acoustic hole may be at least one of the pressure relief hole 111c or the sound tuning hole 111d, and the bracket 115 may include an acoustic channel 1151 that is in flow communication with the acoustic hole and the acoustic cavity 116, so that the acoustic cavity 116 is connected to an external environment, i.e., air may freely flow in and out of the acoustic cavity 116, which is conducive to reducing the resistance of the diaphragm of the speaker 112 during vibration.

Further, the bracket 115 may cooperate with the core housing 111 to form a first adhesive-containing groove 1171 surrounding at least a portion of the acoustic hole, and the first adhesive-containing groove 1171 may contain a first adhesive for sealing an assembly gap between the bracket 115 and the core housing 111, i.e., waterproof sealing through the first adhesive, which is conducive to preventing the intrusion of droplets such as sweat, rainwater, or the like, from the external environment into the space where the main control circuit board 13 is located within the core housing 111. In this way, based on the Helmholtz resonance cavity, compared to the related technologies in which a silicone sleeve is held down on the core housing 111 by means of the bracket 115 for waterproof sealing, the present technological solution for waterproof sealing by means of the first adhesive can dispense with the aforementioned silicone sleeve in the related technology, which is conducive to shortening a length of a portion (including the acoustic channel 1151 and the acoustic hole) of the acoustic cavity 116 that is connected to the external environment and enabling the resonance frequency of a leakage sound (i.e., the above-described second leakage sound) propagating out through the pressure relief hole 111c to be shifted as much as possible to a relatively high frequency band (e.g., a frequency range of greater than 4 kHz), thereby further avoiding the second leakage sound from being heard.

It should be noted that, if the acoustic hole is the pressure relief hole 111c, the first adhesive-containing groove 1171 may surround at least a portion of the pressure relief holes 111c; if the acoustic hole is the sound tuning hole 111d, the first adhesive-containing groove 1171 may surround at least a portion of the sound tuning holes 111d; if the acoustic hole is the pressure relief hole 111c and the sound tuning hole 111d, the first adhesive-containing groove 1171 may surround at least a portion of the pressure relief hole 111c and at least a portion of the sound tuning hole 111d, respectively. For ease of description and referring to FIGS. 8, 10, and 12, the present disclosure takes the acoustic hole being the pressure relief hole 111c and the sound tuning hole 111d as an example, and the first adhesive-containing groove 1171 surrounds at least a portion of the pressure relief holes 111c and at least a portion of the sound tuning holes 111d, respectively. Further, if the assembly gap between the bracket 115 and the core housing 111 (e.g., the bottom wall 1113) is sufficiently large, or if the bottom wall 1113 and the first side wall 1114 in the core housing 111 are not an integrally molded structural member (i.e., two separate structural members), the first adhesive-containing groove 1171 may surround all of the aforementioned acoustic hole, i.e., the first adhesive-containing groove 1171 is a complete annular structure.

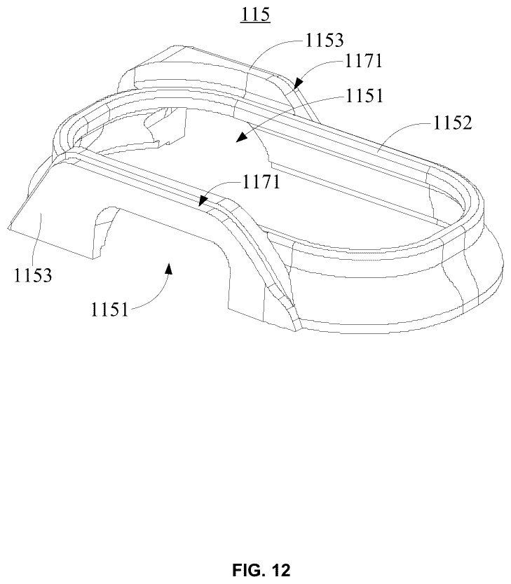

By way of example, referring to FIG. 12 and FIG. 10, the bracket 115 may include an annular main body portion 1152 and a docking portion 1153 connected to the annular main body portion 1152. The annular main body portion 1152 may be sleeved on a periphery of the speaker 112 to form the acoustic cavity 116, and the acoustic channel 1151 may penetrate through the docking portion 1153 and the annular main body portion 1152. Further, the docking portion 1153 may be disposed between the annular main body portion 1152 and the core housing 111 and surround at least a portion of the acoustic hole, and the docking portion 1153 may cooperate with the core housing 111 to form the first adhesive-containing groove 1171. Since the acoustic hole may be the pressure relief hole 111c and the sound tuning hole 111d, correspondingly, two docking portions 1153 and two first adhesive-containing grooves 1171 may be provided, and the two docking portions 1153 may cooperate with the first side wall 1114 to form the two first adhesive-containing grooves 1171, respectively. Since the bracket 115 is configured as an annular shape, a side of the speaker 112 towards the main control circuit board 13 is exposed, which reduces the thickness of the core module 11 in the thickness direction X.

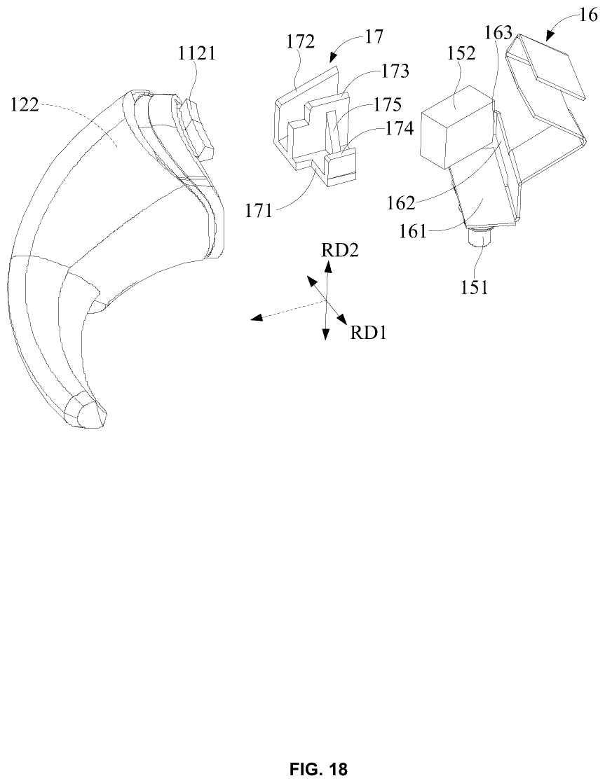

By way of example, referring to FIG. 10 and FIG. 18, the inner side of the core housing 111 may include a recessed region 1119, and the acoustic hole may be located at a bottom of the recessed region 1119. The core module 11 may include an acoustic resistance mesh 118 disposed within the recessed region 1119, and the docking portion 1153 may press the acoustic resistance mesh 118 against the bottom of the recessed region 1119. This configuration prevents the bracket 115 from scraping the acoustic resistance mesh 118 during assembly, narrows an assembly gap between the bracket 115, the acoustic resistance mesh 118, and the inner casing 1111 of the core module 11, and prevents the acoustic resistance mesh 118 from wobbling. The acoustic resistance mesh 118 may be pre-fixed to the bottom of the recessed region 1119 through a double-sided adhesive or glue. The acoustic resistance mesh 118 may also be pre-fixed to a protective steel mesh 119, and the protective steel mesh 119 may then be pre-fixed to the bottom of the recessed region 1119 through a double-sided adhesive or glue. Since the acoustic hole may be the pressure relief hole 111c and the sound tuning hole 111d, the inner side of the core housing may include two recessed regions 1119, and accordingly, two acoustic resistance meshes 118 may be provided.

Further, the first adhesive may further seal an assembly gap between the bracket 115 and the acoustic resistance mesh 118 and/or an assembly gap between the acoustic resistance mesh 118 and the core housing 111 (e.g., a side wall of the recessed region 1119), which further facilitates waterproof sealing.

By way of example, referring to FIG. 8, FIG. 10, and FIG. 12, the docking portion 1153 may be configured to form a bottom wall and one side wall of the first adhesive-containing groove 1171, and the core housing 111 may form another side wall of the first adhesive-containing groove 1171. The side wall of the first adhesive-containing groove 1171 formed by the core housing 111 and the side wall of the first adhesive-containing groove 1171 formed by the docking portion 1153 may be arranged opposite to each other, so that the first adhesive-containing groove 1171 has a certain width and depth. Of course, the docking portion 1153 may be configured to form one side wall of the first adhesive-containing groove 1171, and the core housing 111 may be configured to form the bottom wall and another side wall of the first adhesive-containing groove 1171. Alternatively, the docking portion 1153 may be configured to form one side wall and a portion of the bottom wall of the first adhesive-containing groove 1171, and the core housing 111 may be configured to form another side wall and another portion of the bottom wall of the first adhesive-containing groove 1171.

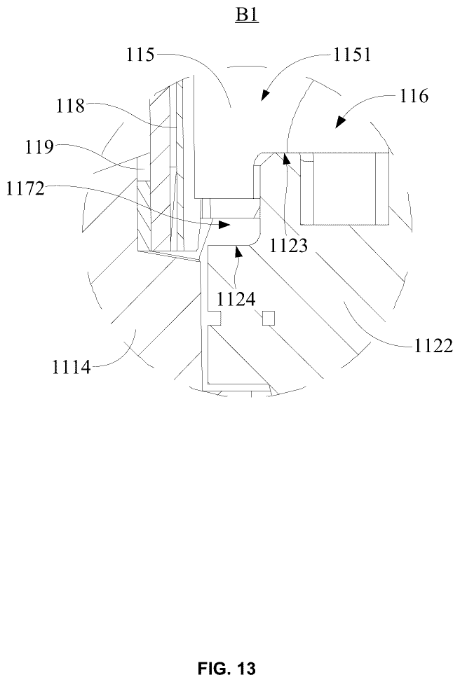

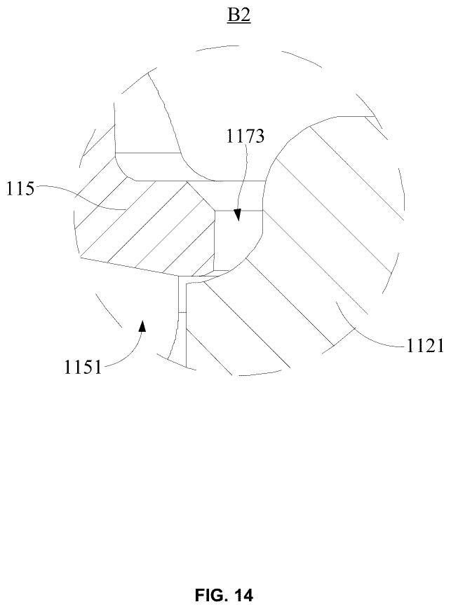

By way of example, referring to FIG. 12 to FIG. 14, the speaker 112 may include a body 1121 and an annular bearing terrace 1122 provided along a circumferential direction of the body 1121. A lower end of the bracket 115 may be supported on the annular bearing terrace 1122. The acoustic channel 1151 may be configured open on a side facing the annular bearing terrace 1122, and the annular bearing terrace 1122 seals the open portion of the acoustic channel 1151. At this point, it may be simply considered that the first adhesive-containing groove 1171 surrounds a portion of the acoustic hole, allowing for subsequent filling of the first adhesive-containing groove 1171 with adhesive using techniques such as dispensing, etc.

In some embodiments, the annular bearing terrace 1122 may include a first annular terrace surface 1123 and a second annular terrace surface 1124 that is configured as a stepped shape, and the second annular terrace surface 1124 may surround a periphery of the first annular terrace surface 1123. A portion of the lower end of the bracket 115 may be supported on the first annular terrace surface 1123, and another portion of the lower end of the bracket 115 may form a gap region with the second annular terrace surface 1124, so that the bracket 115, the annular bearing terrace 1122, and the core housing 111 may cooperate to form a second adhesive-containing groove 1172. The second adhesive-containing groove 1172 may contain a second adhesive for sealing an assembly gap between any two of the bracket 115, the annular bearing terrace 1122, and the core housing 111 for a corresponding waterproof seal.

In some embodiments, an upper end of the bracket 115 may be lapped on the body 1121 of the speaker 112 and cooperate with the body 1121 to form a third adhesive-containing groove 1173. The third adhesive-containing groove 1173 may contain a third adhesive for sealing an assembly gap between the bracket 115 and the body 1121 for waterproof seal.

It should be noted that in a specific assembly process of the core module 11, the following process operations may be included, and the sequence of the operations in the process may be adjusted as needed. (1) The acoustic resistance mesh 118 may be pre-fixed to the bottom of the recessed region 1119 through a double-sided adhesive. (2) The speaker 112 may be fixed to the bottom wall 1113 and an adhesive may be dispensed to the assembly gap between the speaker 112 and the bottom wall 1113, and the corresponding adhesive partially accumulates on the second annular terrace surface 1124 of the speaker 112. (3) The bracket 115 may be fixed to the speaker 112 before the adhesive in operation (2) is cured, and the lower end of the bracket 115 is supported by the first annular terrace surface 1123 of the speaker 112, so that the gap between the lower end of the bracket 115 and the second annular terrace surface 1124 is also filled with the adhesive, and the docking portion 1153 of the bracket 115 presses against the acoustic resistance mesh 118 and cooperates with the first sidewall 1114 to form the first adhesive-containing groove 1171, and the upper end of the bracket 115 is lapped on the body 1121 and cooperates with the body 1121 to form the third adhesive-containing groove 1173. (4) An adhesive may be dispensed to the first adhesive-containing groove 1171, the third adhesive-containing groove 1173, an assembly gap between the lower end of the bracket 115, the speaker 112, and the inner core housing 1111. Since the assembly gap between the lower end of the bracket 115 and the speaker 112 and the assembly gap between the lower end of the bracket 115 and the inner core housing 1111 are close to the first adhesive-containing groove 1171, the assembly gap between the lower end of the bracket 115 and the speaker 112 and the assembly gap between the lower end of the bracket 115 and the inner core housing 1111 may be simply regarded as a continuation of the first adhesive-containing groove 1171, i.e., the first adhesive-containing groove 1171 and the second adhesive-containing groove 1172 may be in flow communication.

By way of example, referring to FIGS. 15 to 18 and FIG. 7, the hook-like structure 12 may include an adapter housing 122 connected to the core module 11, and an accommodation cavity 124 is pre-formed in the adapter housing 122. The earphone 10 may include an electronic component 15 that is subsequently mounted in the accommodation cavity 124. The adapter housing 122 and the core module 11 may be connected through any one of snap-fit, welding, adhesive bonding, threaded connection, or screw connection, or a combination thereof. Compared to the related technology in which the electronic component 15 is provided in the core module 11, by mounting the electronic component 15 within the pre-formed accommodation cavity 124 of the hook-like structure 12, the present disclosure not only saves space in the core module 11, making it structurally more compact and smaller, but also simplifies the structure of the core module 11 for higher assembly efficiency. Additionally, it facilitates a reasonable layout of relative positions of various structural components in the earphone 10, ensuring that both the core module 11 and the hook-like structure 12 are fully utilized.

It should be noted that the accommodation cavity 124 being pre-formed in the adapter housing 122 means that the accommodation cavity 124 is formed simultaneously during the molding of the adapter housing 122, rather than being machined after the adapter housing 122 is molded. For example, if the adapter housing 122 is a plastic housing, the corresponding accommodation cavity 124 may be obtained by incorporating an appropriate core during the injection molding of the plastic housing. Accordingly, the electronic component 15 being subsequently mounted in the accommodation cavity 124 refers to that the electronic component 15 is not integrally molded with the adapter housing 122. For example, if the adapter housing 122 is a plastic housing, the electronic component 15 is not integrally injection molded within the plastic housing using an insert technique. Based on this, a through-hole 1251, a blind hole 1252, and a through-hole 1253, etc., referred to later in the present disclosure are pre-formed in the adapter housing in the same manner and will not be repeated again. Of course, the accommodation cavity 124 may also be obtained through a drilling process after the adapter housing 122 is molded. Similarly, the through-hole 1251, the blind hole 1252, and the through-hole 1253, etc., may also be obtained through a drilling process after the adapter housing 122 is molded.

By way of example, referring to FIG. 7, the electronic component 15 may be connected to the main control circuit board 13 to realize an electrical connection between the hook-like structure 12 and the core module 11, and the adapter housing 122 may be plugged and fixed to the core housing 111 to realize a structural connection between the hook-like structure 12 and the core module 11, which is simple and reliable. The aforesaid plugging and fixation refers to that one of the adapter housing 122 and the core housing 111 is first partially inserted into the other along an assembling direction, and then plugged in and fixed with the aid of another limiting structure such as a pin, wherein an assembly direction of the limiting structure is different from and not parallel to the aforementioned assembling direction. The aforementioned plugging and fixation may also refer to that one of the adapter housing 122 and the core housing 111 is plugged in when it is partially extended into the other without the aid of the aforementioned limiting structure.

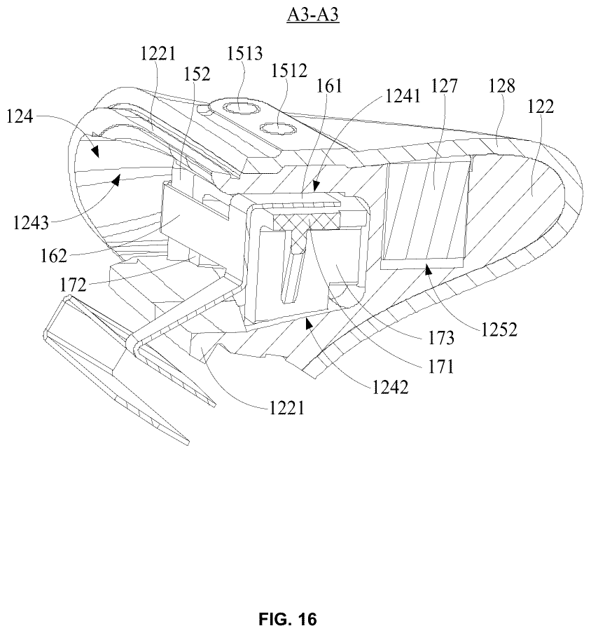

By way of example, referring to FIG. 7, FIG. 10, and FIG. 16, the adapter housing 122 may be provided with a first snap structure 1221, the core housing 111 may be provided with a second snap structure 1222, and the first snap structure 1221 extends into the core housing 111 and snaps with the second snap structure 1222 to cooperate with each other, thereby enabling the structural connection between the adapter housing 122 and the core housing 111, which is simple and reliable. Two first snap structures 1221 may be integrally disposed on the adapter housing 122 and spaced apart relative to each other in the thickness direction X, and two second snap structures 1222 may be integrally disposed on the inner core housing 1111 and arranged in a one-to-one correspondence with the two first snap structures 1221.

By way of example, referring to FIG. 7, the earphone 10 may include a flexible circuit board 16 at least partially disposed within the accommodation cavity 124 to be connected to the electronic component 15 and extend into the core housing 111, such that the electronic components 15 to be connected to the main control circuit board 13 via the flexible circuit board 16. For example, the electronic component 15 may be soldered to one end of the flexible circuit board 16 using a surface mounted technology (SMT), and the other end of the circuit board of the flexible circuit board 16 and the main control circuit board 13 may be snapped together through a BTB connector. The speaker 112 may be configured to be connected to the flexible circuit board 16 on an extension path of the flexible circuit board 16, such as leads of the speaker 112 are soldered to a corresponding region of the flexible circuit board 16, such that the speaker 112 is also connected to the main control circuit board 13 via the flexible circuit board 16, and the leads of the speaker 112 do not need to be extended to be connected to the main control circuit board 13, which is conducive to simplifying the alignment structure of the earphone 10 and reducing production costs.

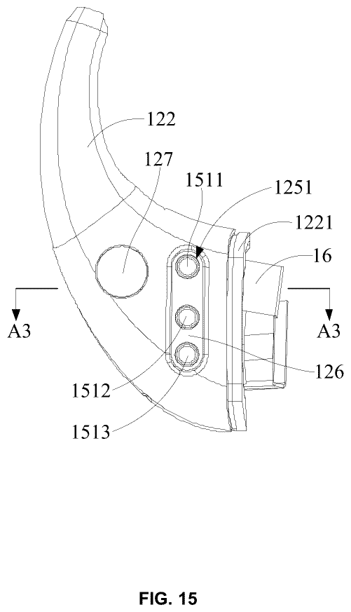

By way of example, referring to FIG. 16 and FIG. 15, the adapter housing 122 may be pre-formed with through-holes 1251 communicating with the accommodation cavity 124, and the electronic component 15 may include an electrode terminal 151 at least partially disposed within the through-holes 1251. The electrode terminal 151 may be a retractable elastic component such as a pogo-PIN or a non-retractable rigid component such as a metal post. A diameter of the through-holes 1251 may be larger than an outer diameter of the electrode terminal 151 to facilitate subsequent addition of the electrode terminal 151. Of course, the electrode terminal 151 may also be integrally molded with the adapter housing 122 in the form of an insert. Furthermore, the electrode terminal 151 may be oriented toward the ear in the wearing state so that the electrode terminal 151 is not visible in the wearing state, which is conducive to improving the appearance of the earphone 10 in the wearing state.

It should be noted that if the electrode terminal 151 is configured as a retractable elastic part such as a pogo-PIN, an extension direction of the electrode terminal 151 may be the direction in which it retracts. If the electrode terminal 151 is configured as a non-retractable rigid part such as a metal post, the extension direction of the electrode terminal 151 may be the direction in which its axis is located.

Further, a plurality of electrode terminals 151 may be provided according to the actual use requirements, such as for charging, detecting, or the like.

In some embodiments, the electrode terminal 151 may include a charging positive terminal 1511 and a charging negative terminal 1512 spaced apart from each other, and the charging positive terminal 1511 and the charging negative terminal 1512 may be disposed in the corresponding through-hole 1251, respectively, so as to facilitate charging of the earphone 10 through the electrode terminal 151. Of course, one of the charging positive terminal 1511 and the charging negative terminal 1512 may be provided on the adapter housing 122, and the other may be provided on another housing such as the battery housing 123 in the hook-like structure 12 or provided on the inner core housing 1111.

In some embodiments, the electrode terminal 151 may include a detection terminal 1513 spaced apart from the charging positive terminal 1511 and the charging negative terminal 1512 from each other, and the detection terminal 1513 may be configured to perform detection functions such as a charging detection, a detection of the earphone 10 into or out of a charging case, or the like. Of course, the detection terminal 1513 may also be replaced by an electronic component such as a Hall sensor.

In some embodiments, when viewed along the extension direction of the electrode terminal 151, lines connecting the charging positive terminal 1511, the charging negative terminal 1512, and the detecting terminal 1513 may form a triangle, such as an equilateral triangle.

In some embodiments, the charging positive terminal 1511, the charging negative terminal 1512, and the detection terminal 1513 may be spaced apart from each other in a line segment, such as arranged in a straight line segment, when viewed along the extension direction of the electrode terminal 151. A spacing between the charging positive terminal 1511 and the charging negative terminal 1512 may be greater than a spacing between the charging negative terminal 1512 and the detection terminal 1513. For example, the charging negative terminal 1512 is disposed between the charging positive terminal 1511 and the detecting terminal 1513, and the spacing between the charging positive terminal 1511 and the charging negative terminal 1512 is greater than the spacing between the charging negative terminal 1512 and the detecting terminal 1513. As another example, the detection terminal 1513 is disposed between the charging positive terminal sub 1511 and the charging negative terminal sub 1512. In this manner, when there is limited space for the provision of the electrode terminals 151 on the adapter housing 122, the spacing between the charging positive terminal 1511 and the charging negative terminal 1512 can be made as large as possible, thereby avoiding short circuits between the charging positive terminal 1511 and the charging negative terminal 1512

Exemplarily, referring to FIG. 15, the outer side of the adapter housing 122 may be provided with a tab 126, and the through-holes 1251 further penetrate through the tab 126 to allow a plurality of electrode terminals 151 to be exposed at the tab 126 respectively. In this way, a local region of the adapter housing 122 that is not flat due to having a certain curvature is made flat by the tab 126 so as to facilitate the setting of the electrode terminals 151. The charging positive terminal 1511, the charging negative terminal 1512, and the detecting terminal 1513 may be spaced sequentially along a length direction of the tab 126.

Exemplarily, referring to FIG. 15 to FIG. 17, the hook-like structure 12 may include a magnet 127, and the magnet 127 and the electrode terminal 151 may be exposed on a same side of the adapter housing 122, i.e., the magnet 127 and the electrode terminal 151 may be visible on a same side surface of the adapter housing 122 to bring the magnet 127 closer to an outside toward which an exposed end of the electrode terminal 151 is facing, thereby shortening a spacing between the magnet 127 and a magnetic suction structure used to cooperate with the magnet 127 in a charging device (e.g., a charging case), or a spacing between the magnet 127 and a Hall sensor used to cooperate with the magnet 127, which facilitates improvement of the reliability of functions such as charging, detection, or the like. The magnet 127 and the electrode terminal 151 may be arranged adjacent to each other to allow the magnet 127 to cooperate with the magnetic suction structure in the charging device, (e.g., the charging case), such that the electrode terminal 151 cooperates with an electrode terminal in the charging device to facilitate charging. Correspondingly, the tab 126 may protrude out of the adapter housing 122 around the magnet 127, i.e., the magnet 127 may be lower than the tab 126 to allow the electrode terminal 151 to come into contact with the electrode terminal in the charging device (e.g., the charging case). Of course, in the embodiment in which the magnet 127 cooperates with a Hall sensor in a charging device such as a charging case for detection, the magnet 127 may be arranged adjacent to the electrode terminal 151, which allows the Hall sensor to be arranged adjacent to the electrode terminal in the charging device (e.g., the charging case) that cooperates with the electrode terminal 151 for charging, thereby reducing an area of the charging device (e.g., the charging case) for carrying the aforementioned electrode terminal and the Hall sensor.

Further, the hook-like structure 12 may include a flexible cover layer 128, the flexible cover layer 128 having a hardness that is less than a hardness of the adapter housing 122. The adapter housing 122 may be a plastic member, and the flexible cover layer 128 may be made of silicone, rubber, etc., and may be formed on the adapter housing 122 by injection molding, glue attachment, etc. Furthermore, the flexible cover layer 128 may cover the adapter housing 122 and the magnet 127, so that the magnet 127 is not exposed and the electrode terminal 151 is exposed, i.e., the magnet 127 is not visible and the electrode terminal 151 is visible. This arrangement satisfies usage requirements of the electrode terminal 151 while also concealing the magnet 127, preventing the magnet 127 from being exposed, which may lead to wear or negatively affect the appearance of the earphone 10. In addition, the flexible cover layer 128 contributes to improving the comfort of the earphone 10 in the wearing state. A thickness of the flexible cover layer 128 is less than a thickness of the adapter housing 122.

Exemplarily, referring to FIG. 16, the adapter housing 122 may be preformed with a blind hole 1252 that is not connected to the accommodation cavity 124 to increase the water and dust resistance of the accommodation cavity 124. The magnet 127 may be provided at least within the blind hole 1252 and exposed via an open end of the blind hole 1252. This arrangement is not only beneficial to reducing the thickness of the adapter housing 122 in the region where the magnet 127 is located, but also beneficial to improving the appearance of the earphone 10 in the region where the magnet 127 is located. Of course, the blind hole 1252 may also be configured as a through hole.

By way of example, referring to FIG. 15, when viewed in the extension direction of the electrode terminal 151, a plurality of electrode terminals 151 may be spaced apart from each other in a line segment, such as a straight line segment or a polyline segment. The magnet 127 may be disposed on either side of the foregoing line segment, or the magnet 127 intersects the foregoing line segment and is at least partially disposed between any two adjacent electrode terminals 151. For example, a count of magnets 127 is one, and the entire magnet 127 is disposed on either side of the foregoing line segment, or the entire magnet 127 intersects with the foregoing line segment and is disposed between any two adjacent electrode terminals 151. As another example: the count of magnets 127 is two, with one magnet 127 being disposed integrally on one side of the foregoing line segment and the other magnet 127 being disposed on the other side of the foregoing line segment. As a further example, the count of magnets 127 is one, a portion of the magnet 127 intersects with the foregoing line segment and is disposed between any two adjacent electrode terminals 151, and another portion is disposed below the electrode terminal 151 in the foregoing extension direction.

Exemplarily, referring to FIG. 15, the plurality of electrode terminals 151 may include a charging positive terminal 1511, a charging negative terminal 1512, and a detecting terminal 1513 arranged in a straight line segment. The magnet 127 may be located on one side of the aforementioned linear segment. Furthermore, when viewed along the extension direction of the electrode terminal 151, a center of the magnet 127 has a first distance, a second distance, and a third distance with a center of the charging positive terminal 1511, a center of the charging negative terminal 1512, and a center of the detecting terminal 1513 respectively, to prioritize charging reliability. It should be noted that in the embodiment in which the hook-like structure 12 is provided with the flexible cover layer 128, in order to conveniently determine a relative positional relationship between the magnet 127, the charging positive terminal 1511, the charging negative terminal 1512, and the detection terminal 1513, the flexible cover layer 128 may be removed first.

Exemplarily, referring to FIG. 16 to FIG. 18, the electronic component 15 may include an electrode terminal 151 and a microphone 152, and the adapter housing 122 may be preformed with a through-hole 1251 and a through-hole 1253 that are in communication with the accommodation cavity 124, respectively. Due to different roles of the electrode terminal 151 and the microphone 152, the through-hole 1251 and the through-hole 1253 may be disposed on different side walls of the adapter housing 122. Based on this, the electrode terminal 151 may be at least partially disposed within the through-hole 1251, and the microphone 152 may be disposed within the accommodation cavity 124 and collect sounds (e.g., a user voice and an environmental sound) outside the earphone 10 via the through-hole 1253. In this way, by reasonably arranging the relative positions of the electrode terminals 151 and the microphone 152, the space of the accommodation chamber 124 is fully utilized, and the structure of the earphone 10 is thus more compact. Further, the earphone 10 may include a support assembly 17 at least partially disposed within the accommodation cavity 124, and the support assembly 17 may support and fix the electrode terminal 151 and the microphone 152 on a side wall of the adapter housing 122 where the through-hole 1251 is located and a side wall of the adapter housing 122 where the through-hole 1253 is located, respectively. In this way, it is not only conducive to preventing the electrode terminal 151 and the microphone 152 from separating from the adapter housing 122, but also conducive to increasing the waterproof and dustproof performance of the electronic component 15, making the structure of the earphone 10 simple and reliable.

By way of example, referring to FIG. 18, the flexible circuit board 16 may include a first circuit board section 161, a second circuit board section 162, and a third circuit board section 163 that are configured as an integral structure. The electrode terminal 151 is soldered to the first circuit board section 161, the second circuit board section 162 is bent with respect to the first circuit board section 161, and the microphone 152 is soldered to the third circuit board section 163 and bent with respect to the second circuit board section 162. In other words, after the flexible circuit board 16 bends twice, the first circuit board section 161, the second circuit board section 162, and the third circuit board section 163 may correspond to three sides of a six-sided structure, with any two of the three sides adjacent to each other. An end of the second circuit board section 162 away from the third circuit board section 163 is connected to the first circuit board section 161, and other portions of the second circuit board section 162 are not connected to the first circuit board section 161. This arrangement allows an operator, after assembling the flexible circuit board 16 and the electrode terminal 151 and microphone 152 inside the adapter housing 122, to press the end of the second circuit board section 162 that connects to the first circuit board section 161, aligning it as closely as possible with the first circuit board section 161 to avoid interference with the subsequently assembled support assembly 17.

In some embodiments, the adapter housing 122 may include two housings with a parting surface that is perpendicular to the extension direction of the electrode terminal 151, with the two housings fitting together to form the accommodation cavity 124. The support assembly 17 may be integrally formed with one of the two housings to support (or press against) the electrode terminal 151 and the microphone 152 respectively when the two housings are engaged. Alternatively, at least one of a first support member for supporting the electrode terminal 151 and a second support member for supporting the microphone 152 in the support assembly 17 may be independent of the adapter housing 122, allowing the first support member and the second support member to support (or press against) the electrode terminal 151 and the microphone 152 respectively when the two housings are engaged, or the support assembly 17 may be assembled after the two housings are engaged to support (or press against) the electrode terminal 151 and the microphone 152 respectively.

In some embodiments, at least a portion of the adapter housing 122 that corresponds to the accommodation cavity 124 is a complete housing structure. Among the first support member in the support assembly 17 for supporting the electrode terminals 151 and the second support member for supporting the microphone 152, at least the first support member may be independent of the adapter housing 122 to at least facilitate the assembly of the electrode terminal 151.

Exemplarily, referring to FIG. 18, the support assembly 17 may be independent of the adapter housing 122 and inserted into the accommodation cavity 124. In this way, since the support assembly 17, the electrode terminal 151, and the microphone 152 are independent of the adapter housing 122, respectively, they may be assembled according to an assembling sequence, thereby avoiding structural interference and making the assembly more efficient.

In some embodiments, the first support member for supporting the electrode terminal 151 and the second support member for supporting the microphone 152 in the support assembly 17 may be independent of the adapter housing 122, i.e., the first support member and the second support member are independent of each other to support (or press against) the electrode terminal 151 and the microphone 152, respectively, thereby enabling differential design of the first support member and the second support member in the support assembly 17 according to actual needs.

In some embodiments, the support assembly 17 may be a one-piece molded structural member, i.e., the first support member for supporting the electrode terminal 151 and the second support member for supporting the microphone 152 in the support assembly 17 are connected to each other, which is not only conducive to simplifying the structure of the support assembly 17, but also avoids the first support member and the second support member being too small and difficult to assemble. The support assembly 17 may be tightly fitted and fixed to a cavity wall of the accommodation cavity 124 after it is inserted into place, i.e., the support assembly 17 is inserted or withdrawn with a certain amount of damping, and the structure is simple and reliable. Correspondingly, the cavity wall of the accommodation cavity 124 may be provided with a guiding slot and a limiting slot with which the support assembly 17 fits. Of course, the support assembly 17 may be further glued to the cavity wall of the accommodation cavity 124 through a dispensing process.

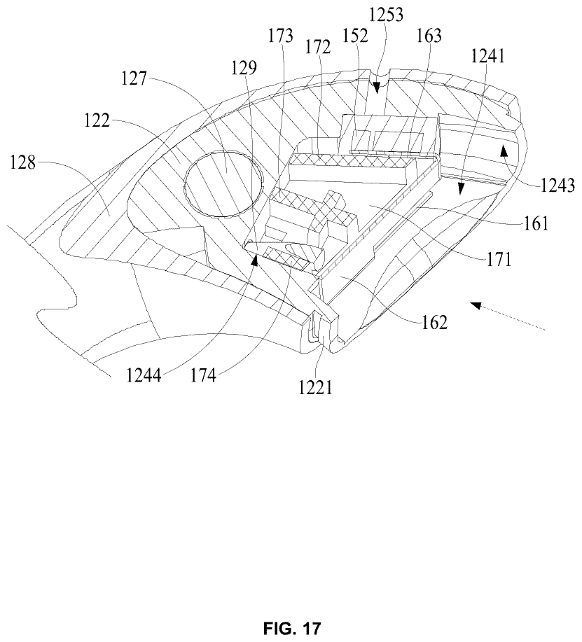

By way of example, referring to FIGS. 17 and 18, the dimensions of at least a portion of the support assembly 17 and the accommodation cavity 124 in at least one reference direction perpendicular to the insertion direction (e.g., the direction indicated by the arrows in FIGS. 17 and 18) of the support assembly 17 with respect to the holding chamber 124 may be set to taper to a smaller size along the foregoing insertion direction dimensions of at least a portion of the support assembly 17 and the accommodation cavity 124 in at least one reference direction are configured to decrease gradually along an insertion direction (e.g., the direction indicated by the arrows in FIGS. 17 and 18) of the support assembly 17 relative to the accommodation cavity 124, the at least one reference direction being perpendicular to the insertion direction, to facilitate the extension of the support assembly 17 into a gap between the electrode terminal 151 and the microphone 152. In other words, the dimension of at least a portion of the support assembly 17 in at least one reference direction perpendicular to the foregoing insertion direction may be configured to decrease gradually along the foregoing insertion direction, and the dimension of at least a portion of the accommodation cavity 124 in the same reference direction may be configured to decrease gradually along the insertion direction, and both of the dimensions have the same or similar trend of change, which facilitates the support assembly 17 to be tightly fitted and fixed on the cavity wall of the accommodation cavity 124 after being inserted in place.

Exemplarily, referring to FIGS. 16 to 18, the cavity wall of the accommodation cavity 124 may include a first cavity wall 1241 and a second cavity wall 1242 disposed side-by-side and spaced apart from each other, and a third cavity wall 1243 connecting the first cavity wall 1241 and the second cavity wall 1242. The through-hole 1251 may be provided in the first cavity wall 1241 and the through-hole 1253 may be provided in the third cavity wall 1243. Correspondingly, the support assembly 17 may include a base plate 171 and a first side plate 172 connected to the base plate 171, e.g., in an L-shaped structure. A main surface of the base plate 171 may be disposed opposite to the first cavity wall 1241 and support the electrode terminal 151, and a main surface of the first side plate 172 may be disposed opposite to the third cavity wall 1243 and support the microphone 152. Thus, after the electrode terminal 151 and the microphone 152 are assembled in place, the support assembly 17 is inserted into the accommodation cavity 124 in the above-described insertion direction, and after the support assembly 17 is inserted in place, the support assembly 17 may support the electrode terminal 151 and the microphone 152 through the base plate 171 and the first side plate 172, respectively.

Further, a positive projection of the microphone 152 on the first cavity wall 1241 may cover at least a portion of the electrode terminal 151, such as the microphone 152 covering a portion of the charging electrode terminal 1511, which facilitates a more compact structure of various parts.

In some embodiments, dimensions of at least a portion of the base plate 171 and the accommodation cavity 124 in a first reference direction RD1 is configured to decrease gradually along the above-described insertion direction, the first reference direction RD1 being perpendicular to the insertion direction and parallel to the main surface of the base plate 171. In other words, a dimension of a front end or a rear end of the base plate 171 in the first reference direction RD1 or a dimension of a portion between the front end and the rear end in the first reference direction RD1 may be kept unchanged along the aforementioned insertion direction. Meanwhile, dimensions of the first side plate 172 and the accommodation cavity 124 in a second reference direction RD2, which is perpendicular to the insertion direction and parallel to the main surface of the first side plate 172, may be configured to remain unchanged along the insertion direction.

In some embodiments, dimensions of at least a portion of the first side plate 172 and the accommodation cavity 124 in the second reference direction RD2 is configured to decrease gradually along the above-described insertion direction, the second reference direction RD2 being perpendicular to the insertion direction and parallel to the main surface of the first side plate 172. In other words, a dimension of a front end or a rear end of the first side plate 172 in the second reference direction RD2 or a dimension of a portion between the front end and the rear end in the second reference direction RD2 may be kept unchanged along the aforementioned insertion direction. Meanwhile, dimensions of the base plate 171 and the accommodation cavity 124 in the first second reference direction RD1, which is perpendicular to the insertion direction and parallel to the main surface of the base plate 171, may be configured to remain unchanged along the insertion direction.

In some embodiments, dimensions of at least a portion of the base plate 171 and the accommodating cavity 124 in the first reference direction RD1 are configured to decrease gradually along the insertion direction, the first reference direction RD1 being perpendicular to the insertion direction and parallel to the main surface of the base plate 171, and dimensions of at least a portion of the first side plate 172 and the accommodating cavity 124 in the second reference direction RD2 are configured to decrease gradually along the insertion direction, the second reference direction RD2 being perpendicular to the insertion direction and parallel to the main surface of the first side plate 172

It should be noted that for the support assembly 17, the dimension of the base plate 171 in the first reference direction RD1 may be simply regarded as a width of the base plate 171, and the dimension of the first side plate 172 in the second reference direction RD2 may be simply regarded as a height of the first side plate 172.

By way of example, referring to FIG. 16 to FIG. 18, the support assembly 17 may include a second side plate 173 connected to the base plate 171, and the second side plate 173 and the first side plate 172 are disposed side by side with each other and spaced apart on a same side of the base plate 171. The second side plate 173 abuts against the second cavity wall 1242 to provide a support force toward the electrode terminal 151 for the base plate 171, thereby improving the support effect of the support assembly 17 on the electrode terminal 151. In the embodiment in which the electrode terminal 151 includes a charging positive terminal 1511 and a charging negative terminal 1512 spaced apart from each other along a direction perpendicular to the above-described insertion direction, the second side plate 173 may be disposed between the charging positive terminal 1511 and the charging negative terminal 1512, so as to make forces applied on the various portions of the electrode terminal 151 uniform, which is conducive to improving the support effect of the support assembly 17 on the electrode terminal 151.

By way of example, referring to FIG. 16 through FIG. 18, the cavity wall of the accommodation cavity 124 may include a fourth cavity wall 1244 that connects the first cavity wall 1241 and the second cavity wall 1242 and is arranged opposite to the third cavity wall 1243. The first cavity wall 1241 and the second cavity wall 1242 may be configured as planar structures substantially parallel to each other, and the third cavity wall 1243 and the fourth cavity wall 1244 may be configured as curved structures substantially flared out from each other to maximize a volume of the accommodation cavity 124 when a volume of the adapter housing 122 is limited. Correspondingly, the support assembly 17 may include a third side plate 174 connected to the base plate 171, the first side plate 172 and the third side plate 174 are disposed on two side edges of the base plate 171, respectively, in a direction perpendicular to the insertion direction described above, and the second side plate 173 is disposed between the first side plate 172 and the third side plate 174. The third side plate 174 abuts against the fourth cavity wall 1244 to provide a support force toward the microphone 152 for the first side plate 172, which is conducive to improving the support effect of the support assembly 17 on the microphone 152.

Furthermore, for the base plate 171, a height of the second side plate 173 may be greater than a height of the first side plate 172 and a height of the third side plate 174, respectively, so as to allow for the second side plate 173 to abut against the second cavity wall 1242 and the third side plate 174 to abut against the fourth cavity wall 1244. The second side plate 173 and the third side plate 174 do not come into direct contact with any one of the electrode terminal 151 or the microphone 152, allowing them to guide the support assembly 17 during its insertion into the accommodation cavity 124. Accordingly, since the height of the second side plate 173 is relatively greater, the support assembly 17 may include reinforcing ribs 175 connecting the second side plate 173 and the base plate 171. The reinforcing ribs 175 may be positioned on opposite sides of the second side plate 173, facing the first side plate 172 and the third side plate 174.

Exemplarily, referring to FIG. 15 to FIG. 17 and FIG. 9, the hook-like structure 12 may include an elastic metal wire 121, an adapter housing 122, a battery housing 123, and a conductor 129. Two ends of the elastic metal wire 121 and the conductor 129 may be respectively connected to the adapter housing 122 and the battery housing 123, such that the conductor 129 extends along the elastic metal wire 121 and is threaded within the adapter housing 122 and the battery housing 123. Of course, the conductor 129 may also be threaded within a preset threading channel after the elastic metal wire 121 is connected to the adapter housing 122 and the battery housing 123. A battery 14 may be disposed within the battery housing 123 and connected to the flexible circuit board 16 through the conductor 129, which in turn causes the battery 14 to be connected to the main control circuit board 13 through the flexible circuit board 16, thereby simplifying the alignment structure of the earphone 10 and reducing production costs. In other words, components such as the electrode terminal 151, the microphone 152, and the battery 14 in the hook-like structure 12 may be connected to the main control circuit board 13 via the flexible circuit board 16.

Furthermore, the flexible cover layer 128 may at least wrap around the exposed portion of the flexible metal wire 121 and the conductor 129, as well as at least a portion of the battery 123, which prevents conductor 129 from being exposed, thereby improving the appearance of the earphone 10.

It should be noted that the adapter housing 122 may also be structured as a part of the core housing 111. For example, the adapter housing 122 is integrally molded with the inner core housing 1111. As another example, a portion of the adapter housing 122 is integrally molded with the inner core housing 1111 and the remaining portion is integrally molded with the outer core housing 1112. A portion of the hook-like structure 12 other than the adapter housing 122 (e.g., an end of the elastic metal wire 121 that is away from the battery housing 123, the battery housing 123, etc.) is fixedly connected (e.g., plug-in fixation) to the core module 11 having the adapter housing 122 at a position of the adapter housing 122. Positions of the structural components such as the electrode terminal 151, the microphone 152, and the magnet 127 are adjusted accordingly, which will not be described herein.

Based on the foregoing description, the present application provides a housing assembly which may include a plastic housing, a metal function pattern, and a silicone overlay. The metal function pattern is provided on an outer side of the plastic housing. The silicone overlay covers a side of the metal function pattern facing away from the plastic housing and a region of the plastic housing not covered by the metal function pattern by means of one-piece injection molding, glue connection, or the like. Thus, compared to the metal function pattern being placed on an inner side of the plastic housing away from the silicone overlay, positioning the metal function pattern on an outer side of the plastic housing toward the silicone overlay allows it to be further away from the interference of other electronic components within the housing assembly or closer to an external signal trigger source, thereby increasing an anti-interference ability and sensitivity of the metal function pattern. A structure of the plastic housing may be the same as or similar to that of the core housing 111 or the outer core housing 1112, and a structure of the silicone overlay may be the same as or similar to that of the flexible cladding 1132, which will not be repeated here.

In some embodiments, the metal function pattern may be configured as an antenna pattern 1141 or a touch pattern 1142. The antenna pattern 1141 may be arranged on the outer side of the plastic housing, which may increase a spacing between the antenna pattern 1141 and other electronic components in the plastic housing, i.e., increase the antenna clearance area, thereby increasing the anti-interference ability of the antenna pattern 1141. The touch pattern 1142 may be arranged on the outer side of the plastic housing, which may shorten a spacing between the touch pattern 1142 and the external signal trigger source (e.g., a finger of the user), i.e., reduce a touching spacing, thereby increasing the sensitivity of the touch pattern 1142 to user triggers.

In some embodiments, the metal function pattern may include an antenna pattern 1141 and a touch pattern 1142, and the antenna pattern 1141 may surround a periphery of the touch pattern 1142 to fully utilize the space on the outer side of the plastic housing. The antenna pattern 1141 may be configured as a U-shape, and the touch pattern 1142 may be configured as a square shape.

In some embodiments, a thickness of the silicone overlay may be smaller than a thickness of the plastic housing to further increase the anti-interference and sensitivity of the metal function pattern while the silicone overlay covers and protects the metal function pattern, as well as to reduce a volume of the housing assembly.

Exemplarily, the housing assembly may function as a core housing that houses the speaker 112. The relative positional relationship between the plastic housing and the plastic cladding may be the same or similar to that between the core housing 111 and the flexible cladding 1132, which will not be repeated herein.

Further, the housing assembly may be applied to other electronic devices such as smart glasses in addition to the earphone 10. The electronic device may include a core module provided with a speaker 112, and may also include a main control circuit board 13, and a speaker 112 and a battery 14 connected to the main control circuit board 13, respectively. The housing assembly may be configured to house at least one of the electronic components, such as the speaker 112, the main control circuit board 13, the battery 14, or the like. The housing assembly may be configured to support the speaker 112 in the electronic device in a corresponding wearing position. It should be noted that for electronic devices such as earphones and smart glasses based on the principle of bone conduction, the speaker 112 may be adaptively configured as a bone conduction speaker, and the basic structure of the bone conduction speaker is well known to those skilled in the art, which will not be repeated herein.

The present disclosure provides a housing assembly, the housing assembly may include a first housing, an electrode terminal 151, a magnet 127, and a flexible cover layer 128. The electrode terminal 151 and the magnet 127 may be exposed on a same side of the first housing. The flexible cover layer 128 has a hardness less than a hardness of the first housing and covers the first housing and the magnet 127 such that the magnet 127 is not exposed and the electrode terminal 151 is exposed. In this way, compared to the magnet 127 being provided in the first housing, the present technical solution allows the magnet 127 to be located closer to the outside world toward which an exposed end of the electrode terminal 151 is facing, thereby reducing a spacing between the magnet 127 and a magnetic suction structure in a charging device (e.g., a charging case) that cooperates with the magnet 127, or reducing a spacing between the magnet 127 and a Hall sensor that cooperates with the magnet 127, which is conducive to improving the reliability of functions such as charging, detection, or the like, of the housing assembly. Thus, the housing assembly can be applied to both powered devices such as an earphone 10, smart glasses, and charging devices such as a charging case. In other words, the electronic device can be a powered device or a charging device. For ease of description, the first housing may be the adapter housing 122.

In some embodiments, the first housing may be provided with through-holes 1251 and a blind hole 1252. The electrode terminal 151 may be provided at least partially within the through-holes 1251, and the magnet 127 may be provided at least partially within the blind hole 1252 and exposed via an open end of the blind hole 1252. This arrangement is not only beneficial to reducing a thickness of the first housing in the region where the magnet 127 is located, but also beneficial to improving the appearance of the first housing in the region where the magnet 127 is located. Of course, the blind hole 1252 may also be configured as a through hole.

In some embodiments, an outer side of the first housing may be provided with a tab 126. The tab 126 may be arranged adjacent to the magnet 127 and protrude out of the first housing around the magnet 127, and the through-holes 1251 further penetrate through the tab 126 to allow a plurality of electrode terminals 151 to be exposed at the tab 126. In this way, the first housing, which is not flat due to having a certain curvature, is made locally flat by the tab 126 so as to facilitate the setting of the electrode terminals 151. The tab 126 may be configured as an elongated shape, with a simple and reliable structure.

In some embodiments, the housing assembly may include a flexible circuit board 16, with the electrode terminals 151 connected to the flexible circuit board 16 to simplify the alignment structure of the electrode terminals 151. The first housing may be provided with an accommodation cavity 124, at least a portion of the flexible circuit board 16 may be disposed within the accommodation cavity 124, the through-holes 1251 is in communication with the accommodation cavity 124, and the blind hole 1252 is not in communication with the accommodation cavity 124, so as to improve the waterproof and dustproof performance of the first housing.

In some embodiments, the housing assembly may include a second housing, an elastic metal wire 121, and a conductor 129, and two ends of the elastic metal wire 121 and the conductor 129 may be respectively connected to the first housing and the second housing, such that the conductor 129 extends along the elastic metal wire 121 and is threaded within the first housing and the second housing. For ease of description, the second housing may be a battery housing 123. Further, a battery 14 is provided in the second housing, and the battery 14 is connected to the flexible circuit board 16 via the conductor 129, i.e., both the battery 14 and the electrode terminal 151 are connected to the flexible circuit board 16 to simplify the alignment structure. Correspondingly, the flexible cover layer 128 at least wraps around the flexible metal wire 121 and the conductor 129 so as to prevent the conductor 129 from being exposed.

In some embodiments, the housing assembly may be applied to the earphones 10 and may include a third housing for housing the speaker 112, the third housing being plugged and fixed to the first housing. For ease of description, the third housing may be the core housing 111.

The present disclosure provides a housing assembly, wherein the housing assembly may include a first housing, an electrode terminal 151, a microphone 152, and a support assembly 17. The first housing may be provided with an accommodating cavity 124, and a through-hole 1251 and a through-hole 1253 connected to the accommodating cavity 124, respectively, the through-hole 1251 and the through-hole 1253 being disposed on different sidewalls of the first housing. The electrode terminal 151 may be at least partially disposed within the through-hole 1251, the microphone 152 may be provided within the accommodation cavity 124 and configured to collect a sound outside the housing assembly via the through-hole 1253. Further, the support assembly 17 may be disposed within the accommodation cavity 124 and may support and fix the electrode terminal 151 and the microphone 152 to the sidewalls corresponding to the through-hole 1251 and the through-hole 1253, respectively. This arrangement is not only conducive to preventing the electrode terminal 151 and the microphone 152 from separating from the first housing, but also conducive to increasing the waterproof and dustproof performance at the electrode terminal 151 and the microphone 152, making the structure simple and reliable. For ease of description, the first housing may be the adapter housing 122, the core housing 111, or a housing structure after the core housing 111 and the adapter housing 122 are integrally molded.

In some embodiments, the support assembly 17 may be separated from the first housing and inserted into the accommodation cavity 124.

In some embodiments, the support assembly 17 may be a one-piece molded structural member.

In some embodiments, the housing assembly may be applied to the earphone 10 and may include a third housing for housing the speaker 112, the third housing being plugged and fixed to the first housing. The first housing may be the adapter housing 122 and the third housing may be the core housing 111.

Further, the housing assembly may be applied to other electronic devices such as smart glasses in addition to the earphone 10. The electronic device may include a main control circuit board 13, and a speaker 112 and a battery 14 connected to the main control circuit board 13, respectively. The housing assembly may be configured to house at least one of the speaker 112, the main control circuit board 13, the battery 14, or the like, and may also be configured to support the speaker 112 in the electronic device in a corresponding wearing position. It should be noted that for electronic devices such as earphones and smart glasses based on the principle of bone conduction, the speaker 112 may be adaptively configured as a bone conduction speaker, and the basic structure of the bone conduction speaker is well known to those skilled in the art, which will not be repeated herein.

The preceding descriptions are only a part of the embodiments of the present disclosure and are not intended to limit the scope of protection of the present disclosure. Any equivalent device or equivalent process transformations utilizing the contents of the present disclosure and the accompanying drawings, or applying them directly or indirectly in other related technical fields, are similarly included in the scope of protection of the present disclosure.

What is claimed is:

1. An earphone comprising:
a core module and a hook-like structure connected to the core module, the core module being located on a front side of an ear in a wearing state, and at least part of the hook-like structure being located on a rear side of the ear in the wearing state, wherein
the hook-like structure includes an adapter housing connected to the core module, an accommodation cavity is pre-formed in the adapter housing, and
the earphone further comprises an electronic component that is subsequently mounted in the accommodating cavity.

2. The earphone of claim 1, wherein the core module includes a core housing, and the adapter housing is integrally formed with the core housing.

3. The earphone of claim 2, wherein the core housing includes an inner core housing and an outer core housing, a portion of the adapter housing is integrally formed with the inner core housing, and the other portion of the adapter housing is integrally formed with the outer core housing.

4. The earphone of claim 1, wherein
the core module includes a core housing, and a speaker and a main control circuit board disposed in the core housing,
the speaker and the electronic component are respectively coupled with the main control circuit board, and
the adapter housing is plugged and fixed with the core housing.

5. The earphone of claim 4, wherein
the adapter housing is provided with a first snap structure,
the core housing is provided with a second snap structure, and
the first snap structure extends into the core housing and snaps with the second snap structure to cooperate with each other.

6. The earphone of claim 4, further comprising a flexible circuit board, wherein
the flexible circuit board is connected to the electronic component and extends into the core housing, such that the electronic component is connected to the main control circuit board via the flexible circuit board, and
the speaker is configured to be connected to the flexible circuit board on an extension path of the flexible circuit board, such that the speaker is connected to the main control circuit board via the flexible circuit board.

7. The earphone of claim 6, wherein the speaker and the flexible circuit board are connected by leads welding.

8. The earphone of claim 6, wherein the flexible circuit board includes a first circuit board section, a second circuit board section, and a third circuit board section, the second circuit board section is bent with respect to the first circuit board section, and the third circuit board section is bent with respect to the second circuit board section, such that the first circuit board section, the second circuit board section, and the third circuit board section are adjacent to one another in pairs.

9. The earphone of claim 6, wherein
the adapter housing is pre-formed with through-holes in communication with the accommodation cavity,
the electronic component includes electrode terminals at least partially provided within the through-holes,
the electrode terminals face toward the ear in the wearing state,
the electrode terminals include a charging positive terminal and a charging negative terminal spaced apart from each other, and
the charging positive terminal and the charging negative terminal are disposed in the corresponding through-hole, respectively.

10. The earphone of claim 9, wherein the electrode terminals further include a detection terminal arranged apart from the charging positive terminal and the charging negative terminal, the detection terminal being configured to perform charging detection or detection of the earphone into or out a charging case.

11. The earphone of claim 10, wherein when viewed along an extension direction of the electrode terminals, the charging positive terminal, the charging negative terminal, and the detection terminal are spaced apart from each other in a line segemnt and:
the charging negative terminal is positioned between the charging positive terminal and the detection terminal, and a spacing between the charging positive terminal and the charging negative terminal is greater than a spacing between the charging negative terminal and the detection terminal, or
the detection terminal is positioned between the charging positive terminal and the charging negative terminal.

12. The earphone of claim 10, wherein an outer side of the adapter housing is provided with a tab, the through-holes penetrates the tab to allow the electrode terminals to be exposed at the tab, and the charging positive terminal, the charging negative terminal, and the detection terminal are spaced sequentially along a length direction of the tab.

13. The earphone of claim 9, wherein
the adapter housing is pre-formed with a blind hole which is not connected to the accommodation cavity,
the blind hole is provided with a magnet, and
the magnet and the electrode terminals are visible on a same side surface of the adapter housing.

14. The earphone of claim 6, wherein
the hook-like structure includes an elastic metal wire and a conductor,
an end of the elastic metal wire is connected to the adapter housing, and
the conductor extends along the elastic metal wire and is threaded in the adapter housing.

15. The earphone of claim 14, further comprising a battery housing connected to the other end of the flexible metal wire, wherein
the conductor is further threaded in the battery housing,
the battery housing is provided with a battery,
the battery is connected to the flexible circuit board through the conductor, such that the battery is connected to the main control circuit board via the flexible circuit board.

16. The earphone of claim 14, wherein the hook-like structure further includes a flexible cladding, a hardness of the flexible cladding is less than a hardness of the adapter housing, and a thickness of the flexible cladding is less than a thickness of the adapter housing.

17. The earphone of claim 16, wherein the flexible cladding covers the adapter housing and a magnet.

18. The earphone of claim 4, wherein
an inner side, facing the ear in the wearing state, of the core housing is provided with an acoustic outlet hole,
a sound wave generated by the speaker is propagated out through the acoustic outlet hole,
the core module cooperates with a cavum conchae of the ear in the wearing state to form an auxiliary cavity connected to an external ear canal of the ear, and
the acoustic outlet hole is at least partially disposed in the auxiliary cavity.

19. The earphone of claim 18, wherein the core module has a connecting end that is connected to the hook-like structure and a free end that is not connected to the hook-like structure, the free end extends into the cavum conchae, and the auxiliary cavity is formed by the inner side of the core housing and the cavum conchae.

20. The earphone of claim 18, wherein the auxiliary cavity is configured as a semi-open cavity.
